(19) United States
(12) Patent Application Publication
(10) Pub. No.: US 2026/0241363 A1
(43) Pub. Date: Aug. 20, 2026

(54) COMPOSITE MATERIAL FOR REMEDYING SOILS WITH CONTAMINATION OF HEAVY METALS AND METHOD THEREFOR

(71) Applicant: Beijing University of Chemical Technology, Beijing (CN)

(72) Inventors: Hongjun YU, Beijing (CN); Xiao HE, Guangzhou (CN); Yang TANG, Beijing (CN); Xiaojin YANG, Beijing (CN)

(73) Assignee: Beijing University of Chemical Technology, Beijing (CN)

(21) Appl. No.: 19/643,861

(22) Filed: Apr. 10, 2026

Related U.S. Application Data
(63) Continuation-in-part of application No. 17/919,239, filed on Jul. 28, 2020, now Pat. No. 12,629,653.

(30) Foreign Application Priority Data
Apr. 15, 2020 (CN) 202010294821.6

(51) Int. Cl. B01J 20/04; B01J 20/02; B01J 20/08; B01J 20/28; B01J 20/30; B09C 1/00; B09C 1/08; B09C 1/10; C02F 1/52; C02F 1/66; C02F 1/70; C02F 101/10; C02F 101/16; C02F 101/22; C02F 101/30; C02F 101/34; C02F 101/36; C02F 101/38; C02F 103/06

(52) U.S. Cl. CPC B01J 20/04; B01J 20/0248; B01J 20/08; B01J 20/28004; B01J 20/28021; B01J 20/3021; B01J 20/3078; B09C 1/08; B09C 1/10; C02F 1/5236; C02F 1/66; C02F 1/705; B09C 1/002; B09C 2101/00; C02F 2101/103; C02F 2101/163; C02F 2101/22; C02F 2101/308; C02F 2101/345; C02F 2101/36; C02F 2101/38; C02F 2103/06

(57) ABSTRACT

A composite material, dissolving to perform an in situ self-assemble of two-dimensional Layered Double Hydroxides (LDH) precipitates, consists of 18-70 weight % of aluminum metal, 30-80% weight of a second type of metal, and 0-2 weight % of an auxiliary agent; and forms a micro-nano Alloy@LDH composite material with a core-shell structure. In the invention, a magnesium content is not less than an aluminum content, and some trace components are boron, lanthanum, and/or molybdenum. The present invention is used for soil remediation, and is suitable for chemical removal and degradation of complex contaminants from an acidic to alkaline environment.

### CROSS REFERENCE TO RELATED APPLICATIONS

This application is a continuation-in-part of U.S. application Ser. No. 17/919,239 filed on Apr. 17, 2023. The application Ser. No. 17/919,239 is a national stage application under 35 U.S.C. § 371 of International Application No. PCT/CN2020/105234 filed on Jul. 28, 2020, which claims priority to Chinese Patent Application No. 202010294821.6 filed on Apr. 15, 2020. The entire contents of the above-identified applications are incorporated herein by reference.

### TECHNICAL FIELD

The present invention relates to the field of water or soil remediation, more particularly, to a composite material for removing contaminants from contaminated water or soil and method therefor.

### BACKGROUND

Water is the source of life and one of the main sources of human diseases (more than 80% of human diseases are related to drinking water). Since the middle of the 20th century, the global environmental contamination has become increasingly serious, and cancer has become a major disease threatening human health and life. The chemical contamination of drinking water is one of the main factors causing cancer. At present, 32% of surface water quality in China is classified as VI, V and worse than V, 91% of groundwater are contaminated in different levels, and 67% of groundwater are seriously contaminated. Groundwater pollution causes 190 million people sickness and 60,000 death each year in China. Groundwater contaminates mainly include heavy metals (hexavalent chromium, copper, cadmium, etc.), organics (chlorinated organic solvents and organic dyes such as methyl orange and methyl blue) and nitrate. Notably, groundwater nitrate contamination has become a global problem threatening human and ecological health. High concentration of nitrate in drinking water can lead to methemoglobinemia, “blue baby” disease and cancer, and nitrate concentration in 27% of China's groundwater exceeds the limit of 10 mg/L for drinking water. Groundwater remediation has become an urgent task in the world.

The main method currently adopted is in-situ remediation for the groundwater remediation by injecting the remediation materials into the underground or filling the permeable reactive barriers. Thus, groundwater contaminants are exposed to the remediation materials and removed by physical and chemical adsorption and chemical degradation and so on. The remediation materials mainly include activated carbon and zero iron powder (ZVI) including nano-zero valent iron (nZVI), which are selectively applied according to the pollution situation.

The advantage of activated carbon is its high specific surface area and good adsorption performance. Physical adsorption is the main mechanism of contaminant removal by activated carbon. Activated carbon is effective in adsorption of hydrophobic organics, but it suffers adsorption saturation and is ineffective for water-soluble inorganics (such as heavy metals, nitrate, pentavalent arsenic, etc.)

Oxidizing contaminants (including inorganic and organic matter, such as copper, hexavalent chromium, trichloromethane, carbon tetrachloride, etc.) are rapidly removed by chemical reduction through ZVI, which has a low standard oxidation potential (−0.44V). Compared with micro ZVI (mZVI), nZVI has a higher specific surface area and better adsorption performance. And nZVI has become a common remediation material in groundwater remediation projects. However, nZVI has several problems in a groundwater remediation process:
1. there are poor removal efficiencies for those heavy metal cations with low oxidation potentials (e.g., cadmium, zinc, nickel);
2. nZVI is only applicable to acidic or weak acidic water, not applicable to alkaline water due to the low reduction activity at alkaline conditions, i.e., only useful for a narrow pH range.
3. nZVI is readily passivated and deactivated and dissolved iron ions cause secondary pollution;
4. nZVI and its reaction product (ferric hydroxide) tend to block groundwater flow channels;
5. nZVI is easy to agglomerate and has low poor mobility;
6. nZVI is expensive and its preservation is costly;
7. nZVI has a relatively high specific surface area but has a low selectivity for contaminants and reacts rapidly with water, leading to its rapid inactivation.

In summary, reduction- or adsorption-based remediation materials (e.g., nZVI, and activated carbon) are not effective for the remediation of groundwater contaminated by complex chemicals, such as pentavalent arsenic, heavy metal cations, oxyanions, organics (chlorinated organics and organic dyes such as methyl orange and methyl blue), nitrate, pesticide residues, bisphenol S and other endocrine disruptors, etc.

Therefore, there is an urgent need to develop new materials for groundwater remediation in a wide pH range, ready-to-use and free secondary pollution.

In order to solve the above problems, the invention is made.

### SUMMARY OF THE INVENTION

According to the first aspect of the invention, a composite material for the contaminants removal in water is provided. The composite material includes aluminum source and a second type of metal. Based on the mass percentage, the mass of the aluminum is 18-70% of the composite material, and the mass of the second type of metal is 30-80% of the composite material. The particle size of the composite material is 0.01-3 mm.

Preferably, the second type of metal is selected from alkaline earth metals and/or transition metals. The alkaline earth metals are from one or both of calcium or magnesium, and the transition metals are from one or more of iron, nickel, manganese or zinc.

Preferably, the composite includes an auxiliary agent, which is silicon, silica or stearic acid, based on the mass percentage. The mass of the auxiliary agent does not exceed 2% of the composite.

The second aspect of the invention provides a preparation method of the composite material. The aluminum source and the second type of metal are placed in a ball milling tank. After vacuumed and filled with argon or nitrogen, the tank was rotated at 3000-5000 rpm for 30-120 min. Preferably, when the composite material includes an auxiliary agent, aluminum, the second type of metal and auxiliary agent are simultaneously placed in a ball mill tank during the preparation process.

The third aspect of the invention provides another preparation method of the composite material. The method includes the following steps:
(1) aluminum source and the second metal are put into the sintering furnace, which is vacuumed and filled with argon or nitrogen for 2 to 4 times;
(2) sintering is carried out at a rate of 70-100° C./h to 700-1500° C. and kept for 0.5-3 h;
(3) the sintering furnace is cooled to 200-400° C. at a rate of 100-140° C./h, and then naturally cooled to room temperature;
(4) a particle is broken to less than 3 mm;
(5) the broken particles are put in a ball milling tank. The tank filled is vacuumed and filled with argon or nitrogen. The broken particle is ball milled for 5-30 mins to obtain the composite material.

Preferably, when the composite material includes an auxiliary agent, in the step (5) of the preparation process, an auxiliary agent is added into ball mill tank vacuumed and filled with argon or nitrogen.

Preferably, the aluminum source is elemental aluminum or aluminum-calcium, aluminum-magnesium, aluminum-iron, aluminum-zinc, aluminum-nickel, aluminum-manganese and aluminum-silicon alloy, and the second type of metal source is an alloy consisting of at least one of the elemental calcium, magnesium, iron, zinc, nickel and manganese or alloy including two or more of the elemental calcium, magnesium, iron, zinc, nickel and manganese.

The fourth aspect of the invention provides a method for the composite material to remove contaminants in water. Contaminants in water are removed by REDOX reactions with composite materials. The divalent metal ions, trivalent aluminum ions and hydroxide ions dissolved and released from the composite materials in situ self-assemble with other divalent and trivalent metal cations and anions in contaminated water to form LDH precipitation, which further adsorbs and catalyzes degradation of organic contaminants in water. Organic contaminants mainly refer to chlorinated organic solvents, endocrine disruptors, pesticides and organic dyes.

The contaminants in water are heavy metals, As(V), chlorinated organic solvents, endocrine disruptors, pesticides, organic dyes and/or nitrate. The heavy metal includes heavy metal cation and heavy metal oxygen-containing anion. The heavy metal cation is selected from but not limited to Cu2+, Cd2+, Zn2+ or Ni2+, or Hg2+, Pb2+. The heavy metal oxygen-containing anion is selected from but not limited to CrO42- or Cr2O72-, namely Cr(VI). The chlorinated organic solvent is selected from but not limited to trichloroacetic acid, trichlorophenol, carbon tetrachloride, 2,4,6-trichlorophenol or 2,4,6-trichlorophenol. The endocrine disruptors are selected from but not limited to bisphenol A and bisphenol S. Most of the organic dyes are anionic and only a few are cationic. Anionic organic dye is selected from but not limited to methyl orange, methyl blue or acid orange 7, and cationic organic dye is selected from but not limited to Rhodamine B. Furthermore, the organics in contaminated water also include pesticide residues, herbicide residues, such as glyphosate.

Among the contaminants, arsenic is a non-metallic element, which usually exists in the form of oxygen-containing anion (AsO43-) in water. It has the feature of heavy metals, so it is included in the scope of heavy metals (similar to mercury) in some tables.

Among the contaminants, bisphenol A and bisphenol S are endocrine disruptors which interfere with the endocrine system of humans or animals.

In a preferred embodiment of the third aspect of the invention, the contaminated water also includes carbonate ions, bicarbonate ions, sulfate ions or chloride ions.

When the composite material contacts with the contaminated water, REDOX reactions occur between pollutants and composites in water. Specifically, Cr(VI) is reduced to trivalent chromium ions that left in the contaminated water and some unreacted Cr(VI) in contaminated water is left; Some copper ions, cadmium ions, nickel ions or zinc ions are reduced to copper elemental, cadmium elemental, nickel elemental or zinc elemental, and some unreacted copper ions, cadmium ions, nickel ions or zinc ions in contaminated water is left; nitrate is removed by reducing to nitrogen; In chlorinated organic solvents such as trichloroacetic acid or trichlorophenol, the chlorine atoms are replaced by hydrogen atoms, and the formed chloride ions are left in contaminated water. As(V) is reduced to trivalent arsenate ions; Azo bonds are ruptured in anionic organic dyes such as methyl orange, methyl blue or acid orange 7. After the REDOX reaction, trivalent metal ions (trivalent chromium ions, trivalent aluminum ions), divalent metal ions (copper ion, cadmium ion, nickel ions, zinc ions, magnesium ions), interlayer anion (carbonate ions, bicarbonate ions, chloride ion, arsenate anions, Cr(VI), anionic organic dyes) and hydroxyl ions self-assembled to form LDH in water. Due to the large number of interlayer anions in LDHs, cations (cationic organic dyes) that have not been assembled into LDH can be removed by adsorption, and pollutants such as heavy metals; Chlorinated organic solvents, organic dyes or nitrate removed by REDOX reaction and in situ self-assembly LDH in contaminated water; pesticides (glyphosate) and endocrine disruptors (bisphenol A, bisphenol S) removed by REDOX reactions in contaminated water.

At the same time, in addition to the effect of REDOX and self-assembly LDH, the composite material of the invention can adsorb part of contaminates by contacting with contaminated water.

In terms of the metal composition of the alloy, the pH range of the composite material application can be expanded, because aluminum metal is amphoteric metal. Due to the alloy phase, such as Al13Fe4 (which is similar to Pd on catalytic effect), the nitrogen selectivity of NO3- reduction can be improved. The hydrogenation catalytic reduction of chlorinated organics can be improved by the doping of catalytic materials such as nickel. In the later stage, because the LDH is formed by in situ self-assembly, the contaminants (such as AsO33-) that are difficult to reduce and degrade can be removed by in situ self-assembly LDH. The LDH itself continues to remove contaminants by adsorption, ion exchange, isomorphic substitution or surface complexation. Because LDH is a natural mineral, the risk of secondary contamination is minimal.

In the third aspect of the invention, preferably, the reaction temperature is 15 to 45° C. and the pH of the contaminated water is less than 10.

In the third aspect of the invention, preferably, the contaminated water can be, but is not limited to groundwater, industrial sewage, pit water, tailings water and contaminated surface water. Contaminated water is contacted with composite materials, and divalent metal ions, trivalent aluminum ion and hydroxyl ions are released. The divalent and trivalent cations and anions in contaminated water self-assemble in situ to form layered two-dimensional bimetallic hydroxides, which are deposited at the bottom of static water bodies or downstream of dynamic water bodies. Taking the remediation of contaminated groundwater as an example, the contaminated groundwater is contacted with the composite material by injecting the composite material into the ground or constructing a permeable reactive barrier filled with composite material. REDOX reactions occur between contaminants and composites in contaminated water. The divalent magnesium ions, trivalent aluminum ions and hydroxide ions released by the composite material dissolution, in situ self-assemble with and the divalent and trivalent cations and anions in contaminated water, to form LDH, which is deposited at the bottom of static groundwater bodies or downstream of flowing groundwater bodies.

Compared with the prior art, the invention has the following beneficial effects.
1. Contaminants are removed by a combination of REDOX reactions and in situ self-assembly LDH in this invention. The composite material prepared in the invention has good removal effect on organic dyes (methyl blue), heavy metals [Cu2+, Cd2+, Zn2+, Ni2+, Cr(VI), As(V)], chlorinated organic solvents (2,4,6-trichlorophenol), endocrine disruptors (bisphenol S), nitrate and pesticide residues (glyphosate) in groundwater. The composite material has a wide range of applications, especially for the heavy metals and nitrate removal. The nitrate removal rate is close to 100% after reaction 9 h, at initial pH 1.5 and temperature of 15° C., although the nitrate is difficult to remove by reduced iron powder and LDH.
2. Composite prepared in this invention react with contaminants to generate trivalent ions and bivalent ions and anions, which self-assemble to form LDH. The LDH with a large particle size, gradually settle on the bottom of the bottle during the standing process. Use composite prepared in this invention as the remediation material. The contaminated groundwater is contacted with the composite material by injecting the composite material into the ground or constructing a permeable reactive barrier filled with composite material. REDOX reactions occur between contaminants and composites in contaminated water. The divalent magnesium ions, trivalent aluminum ions and hydroxide ions released by the composite material dissolution, in situ self-assemble with and the divalent and trivalent cations and anions in contaminated water, to form LDH, which is deposited at the bottom of static groundwater bodies or downstream of flowing groundwater bodies, and not cause the chroma problem and secondary pollution. In addition, the formed LDH is harmless to the human body.
3. Composites prepared in this invention, can effectively remove pesticides, organic pollutants, nitrate nitrogen, heavy metals, As(V) and endocrine disruptors in acidic, neutral and alkaline water. For composites application, pH range is wide and the remediation way is moderate. Namely, under the moderate condition, composite slow dissolve to generate various ions. Compared with the remediation ways in existing technology used under alkaline conditions, this technology avoid directly dumping of alkali into water and high alkali concentration in local water, which is harm to aquatic ecosystems. The invention is especially suitable for the strongly acidic contaminated water. For the strongly acidic contaminated water, many types of contaminants can be removed, meanwhile, the pH value is stable at 8-9 without additional alkali after remediation, which meets water quality standards. However, the conventional water treatment technology to treat acidic wastewater usually requires additional alkali to neutralize the acid in the water, and the control requirement of the alkali amount is extremely demanding, and it is very easy to cause the pH value of water to exceed the standard.
4. The composite material of the invention for contaminants removal adapt to low water temperature in contaminated water. The composite material prepared by the invention has good removal effect on organic dyes (methyl blue), heavy metals [Cd2+, Cr(VI), As(V)], mercury, chlorinated organic solvents (2,4,6-trichlorophenol), endocrine disruptors (bisphenol S), nitrate and pesticide residues (glyphosate) even at the temperature of 15° C. in water. This material with strong practicality is suitable for injecting into the ground or filling a permeable reactive barrier as a remediation material.
5. The composite material used in the invention is cheap and easy to obtain. The preparation process is simple. The product generated after the reaction is LDH, which belongs to a naturally occurring clay, not toxic, not harmful.

For heavy metals contaminated paddy soils, a conventional in situ remediation technology is to apply lime or a CaO-based composite material, resulting in a poor stability and a poor long-term effectiveness, making disruption of soil acid-base balance, making destruction of soil aggregates, making death of beneficial soil microorganisms, and making soil compaction and salinization, thereby damaging a natural soil ecological environment and degrading grain quality and reducing crop yields.

In contrast, a single application of the composite material according to the present invention can achieve an ultra-stable and long-term passivation as well as remediation of soil heavy metals, improving a fertilizer efficiency, enhancing soil structure, increasing and maintaining a microbial community abundance. Consequently, a rice Cd content is far below a safety limit and a rice grain yield is significantly improved. The claimed composite material for in situ remediation of heavy metals contaminated paddy soils in the present invention is dominated by magnesium followed by aluminum and trace elements boron, lanthanum, and molybdenum.

### Application:

The composite materials prepared by different methods of the invention are used for soils with varying pollution levels.

For heavily metal-contaminated soil in which crop cultivation is not recommended, the composite material prepared by a “mechanically ball milling method” is used to achieve rapid remediation. The mechanical ball milling method is simple, fast and inexpensive, and the equipment and maintenance costs are low. The method is characterized that material particles have irregular shape, unsmooth surface, and rapid release of magnesium and aluminum ions, thus achieving rapid remediation of contaminated soils.

For moderately contaminated soil, the material prepared by the “melt atomization+mechanical ball milling” method is recommended to achieve “simultaneous remediation and cultivation”, thus offsetting the cost of remediation. The melt atomization+mechanical ball milling technology has stringent requirements and high equipment and production costs; the composite materials contain β-Mg17Al12 alloy phase and the particle surface is anchored with nanoparticles of trace elements. A durability of the composite materials is superior to that of the composite materials prepared by the mechanical ball milling method.

For lightly contaminated soil, the material prepared by the “melt atomization” method is recommended to achieve “simultaneous remediation and cultivation”, thus offsetting the cost of remediation. The melt atomization technology has stringent requirements and high equipment and production costs; the material consists of smooth-surfaced spherical particles and β-Mg17Al12 alloy phase, and presents good durability.

### Technical Effects

Merits of the present application includes an ultra-stable passivation and mineralization of heavy metals, a slow release of beneficial trace elements, a great improvement of a soil structure, a regulation of a soil redox potential and pH, an enrichment of soil microbial communities, a promotion of a crop growth, and an improvement of a crop yield and a rice quality.

### Technical Principle

The main components, metallic magnesium and metallic aluminum, along with those trace components slowly dissolve and release magnesium, aluminum, trace elements ions, and trace amounts of hydrogen into the soil. Magnesium and aluminum ions are directly self-assembled into those nano-layered magnesium-aluminum intercalation materials in the soil, while simultaneously incorporating heavy metals into the crystal lattice in-situ, achieving ultra-stable passivation and mineralization of heavy metals, supplementing secondary and trace elements for plant growth, improving soil structure, and regulating soil redox potential and pH.

### BRIEF DESCRIPTION OF THE DRAWINGS

FIG. 1A is the SEM image of composite material sample 1 prepared in Embodiment 1 in accordance with an example of the invention.

FIG. 1B is the SEM image of product obtained after reaction of composite material sample 1 in accordance with an example of the invention.

FIG. 2 is the XRD pattern of the reaction products obtained after the reaction of composite material sample 1 in accordance with an example of the invention.

FIG. 3 is the XRD pattern of the reaction products obtained after the reaction of composite material sample 2 in accordance with an example of the invention.

FIG. 4 is the XRD pattern of the reaction products obtained after the reaction of composite material sample 3 in accordance with an example of the invention.

FIG. 5 is the XRD pattern of the reaction products obtained after the reaction of composite material sample 5 in accordance with an example of the invention.

FIG. 6 is the XRD pattern of the reaction products obtained after the reaction of composite material sample 6 in accordance with an example of the invention.

FIG. 7 is the XRD pattern of the reaction products obtained after the reaction of composite material sample 7 in accordance with an example of the invention.

FIG. 8 is the XRD pattern of the reaction products obtained after the reaction of composite material sample 8 in accordance with an example of the invention.

FIG. 9 is the XRD pattern of the reaction products obtained after the reaction of composite material sample 9 in accordance with an example of the invention.

FIG. 10 is the XRD pattern of the reaction products obtained after the reaction of composite material sample 10 in accordance with an example of the invention.

FIG. 11 is the XRD pattern of the reaction products obtained after the reaction of composite material sample 11 in accordance with an example of the invention.

FIG. 12 is the XRD pattern of the reaction products obtained after the reaction of composite material sample 12 in accordance with an example of the invention.

FIG. 13 is the XRD pattern of the reaction products obtained after the reaction of composite material sample 13 in accordance with an example of the invention.

FIG. 14 is the XRD pattern of the reaction products obtained after the reaction of composite material sample 14 in accordance with an example of the invention.

FIG. 15 is the XRD pattern of the reaction products obtained after the reaction of composite material sample 15 in accordance with an example of the invention.

FIG. 16A is SEM micrographs of Al—Mg alloy and Al—Mg@LDH.

FIG. 16B is SEM-mapping of Al—Mg alloy and Al—Mg@LDH.

FIG. 16C is XRD of Al—Mg alloy and Al—Mg@LDH.

FIG. 16D is FT-IR of Al—Mg alloy and Al—Mg@LDH.

FIG. 17A shows a chemical reduction of nitrate by Al—Mg@LDH (0.5 g Al—Mg@LDH in 50 mL, the alloy is coated with LDH using pH 1 HCl at room temperature for 6 hours). Initial pH 6.04; temperature 25±0.5° C.

FIG. 17B shows a chemical reduction of nitrate by Al—Mg alloy (0.5 g Al—Mg alloy in 50 mL). Initial pH 6.04; temperature 25±0.5° C.

FIG. 18A makes an illustration of Mg—Al alloy and in situ LDH for removing micropollutants.

FIG. 18B shows SEM image of Mg—Al alloy particle prior to the pollutant removal process.

FIG. 18C shows SEM image of Mg—Al alloy particle after the pollutant removal process.

FIG. 19 is a set of rice cultivars photos after 3 days transplanting.

FIG. 20 is a set of rice cultivars photos after 50 days transplanting (upper panel) polluted and added with LDH, (lower panel) polluted and added with composite material.

FIG. 21 is a set of rice cultivars photos after 50 days transplanting (upper panel) polluted without remediation material, (lower panel) unpolluted soil.

FIG. 22 shows a XRD pattern of the composite material from extra-Example 6 of the present invention for soil remediation and crop quality and yield enhancement before and after remediation.

FIG. 23 shows SEM images of the composite material from extra-Example 6 of the present invention for soil remediation and crop quality and yield enhancement, where FIG. 23 (a) is the original composite material, FIG. 23 (b) is the composite material after remediation, FIG. 23 (c) is an enlarged view of the composite material after remediation, and FIG. 23 (d) shows soil aggregates.

FIG. 24 shows the cadmium leaching concentration during the simulated 100-year soil aging process for the composite material from the extra-Example 6 of the present invention for soil remediation and crop quality and yield enhancement.

FIG. 25A and FIG. 25B show effects of the composite material from extra-Example 7 of the present invention for soil remediation and crop quality and yield enhancement on soil physicochemical properties

FIG. 25A is a diagram showing the effect on pH

FIG. 25B is a diagram showing the effect on Eh.

FIG. 26 shows an effect of the composite material from extra-Example 8 of the present invention for soil remediation and crop quality and yield enhancement on the microbial community structure of cadmium-contaminated soil (at the phylum level).

FIG. 27 shows an effect of the composite material from extra-Example 8 of the present invention for soil remediation and crop quality and yield enhancement on the microbial community structure of cadmium-contaminated soil (at the genus level).

### DETAILED DESCRIPTION

The present invention is further explained in detail with the attached drawings and examples. It should be understood that the following examples are used only to illustrate the present invention and are not intended to limit the scope of the present invention in any way.

### Example 1-5

Composite material samples 1-5 are prepared by the following methods in EXAMPLE 1-5:

To obtain the composite material, the aluminum source, the second type of metal source and the auxiliary agent are placed in the ball milling tank. After vacuumed and filled with argon or nitrogen, the tank was rotated at 3000-5000 rpm for 30-120 min.

The specific preparation conditions are shown in TABLE 1.

TABLE 1
Preparing Conditions of Composite Material samples 1-5

| | Preparing Condition | | | | | Product | | | |
|---|---|---|---|---|---|---|---|---|---|
| | | The | | | | Mass | Mass | Mass | |
| | | second | | Rotating | Mlling | fraction of | fraction of | fraction | |
| | Aluminum | metal | Auxiliary | speed | time | aluminum | the second | of auxiliary | Size |
| Sample | source | source | agent | (rpm) | (min) | (%) | metal (%) | agent (%) | (mm) |
| Composite | Elemental | Elemental | None | 3000 | 30 | 70 | 30 | 0 | 0.3 |
| material | aluminum | magnesium | | | | | | | |
| sample 1 | | | | | | | | | |
| Composite | Elemental | Elemental | Stearic | 4000 | 60 | 18 | 80 | 2 | 0.1 |
| material | aluminum | zinc | acid | | | | | | |
| sample 2 | | | | | | | | | |
| Composite | Elemental | Magnesium | Stearic | 4000 | 60 | 20 | 79.9 | 0.1 | 0.1 |
| material | aluminum | nickel | acid | | | | | | |
| sample 3 | | alloy | | | | | | | |
| Composite | Elemental | Iron zinc | Silicon | 4000 | 60 | 20 | 79.9 | 0.1 | 0.1 |
| material | aluminum | alloy | | | | | | | |
| sample 4 | | | | | | | | | |
| Composite | Elemental | Calcium | Silicon | 5000 | 120 | 40 | 58 | 2 | 0.01 |
| material | aluminum | magnesium | dioxide | | | | | | |
| sample 5 | | nickel | | | | | | | |
| | | alloy | | | | | | | |

### Example 6-15

Composite material samples 6-15 are prepared by the following methods in EXAMPLE 6-15.
(1) Aluminum source and the second metal are put into the sintering furnace, which is vacuumed and filled with argon or nitrogen for 2 to 4 times;
(2) Sintering is carried out at a rate of 70-100° C./h to 700-1500° C. and kept for 0.5-3 h;
(3) A sintering furnace is cooled to 200-400° C. at a rate of 100-140° C./h, then naturally cooled to room temperature;
(4) The particle is broken to less than 3 mm;
(5) Put the broken particles in a ball milling tank. The tank filled is vacuumed and filled with argon or nitrogen. The broken particle is ball milled for 5-30 mins to obtain the composite material.

The specific preparation conditions are shown in TABLE 2.

TABLE 2
Preparing Conditions of Composite Material Samples 6-15

| | Preparing Condition | | | | | | Product | | | |
|---|---|---|---|---|---|---|---|---|---|---|
| | | The | | | | | Mass | Mass | Mass | |
| | | second | | Calcinating | Calcinating | Mlling | fraction of | fraction of | fraction of | |
| | Aluminum | metal | Auxiliary | temperature | time | time | aluminum | the second | auxiliary | Size |
| Sample | source | source | agent | (° C.) | (h) | (min) | (%) | metal (%) | agent (%) | (mm) |
| Composite | Aluminum | Elemental | Silicon | 700 | 0.5 | 5 | 18 | 80 | 2 | 0.3 |
| material | magnesium | Calcium and | | | | | | | | |
| sample 6 | alloy | Elemental | | | | | | | | |
| | | iron | | | | | | | | |
| Composite | Aluminum | Calcium | Silicon | 700 | 0.5 | 10 | 60 | 39.99 | 0.01 | 0.1 |
| material | magnesium | magnesium | dioxide | | | | | | | |
| sample 7 | alloy | alloy | | | | | | | | |
| Composite | Aluminum | Magnesium | Stearic | 1000 | 1 1 | 15 | 40 | 59.9 | 0.1 | 0.01 |
| material | magnesium | nickel alloy | acid | | | | | | | |
| sample 8 | alloy | | | | | | | | | |
| Composite | Aluminum | Iron zinc | None | 1000 | 1 | 25 | 70 | 30 | 0 | 0.01 |
| material | magnesium | alloy | | | | | | | | |
| sample 9 | alloy | | | | | | | | | |
| Composite | Aluminum | Calcium | Silicon | 1000 | 2 | 30 | 21 | 78 | 1 | 0.01 |
| material | magnesium | magnesium | dioxide | | | | | | | |
| sample | alloy | nickel alloy | | | | | | | | |
| 10 | | | | | | | | | | |
| Composite | Aluminum | Elemental | Silicon | 1500 | 2 | 5 | 18 | 78 | 2 | 0.1 |
| material | iron | Calcium | | | | | | | | |
| sample | alloy | and | | | | | | | | |
| 11 | | Elemental | | | | | | | | |
| | | magnesium | | | | | | | | |
| Composite | Aluminum | Calcium | Silicon | 1500 | 3 | 10 | 40 | 59.99 | 0.01 | 0.1 |
| material | iron | magnesium | dioxide | | | | | | | |
| sample | alloy | alloy | | | | | | | | |
| 12 | | | | | | | | | | |
| Composite | Aluminum | Magnesium | Stearic | 1500 | 3 | 15 | 40 | 58 | 2 | 0.01 |
| material | iron | nickel alloy | acid | | | | | | | |
| sample | alloy | | | | | | | | | |
| 13 | | | | | | | | | | |
| Composite | Aluminum | Iron zinc | None | 1500 | 3 | 25 | 70 | 30 | 0 | 0.3 |
| material | iron | alloy | | | | | | | | |
| sample | alloy | | | | | | | | | |
| 14 | | | | | | | | | | |
| Composite | Aluminum | Calcium | Silicon | 1500 | 3 | 30 | 21 | 78 | 1 | 0.01 |
| material | iron | magnesium | dioxide | | | | | | | |
| sample | alloy | nickel alloy | | | | | | | | |
| 15 | | | | | | | | | | |

### Example 16

ZVI, Mg—Al LDH and composite material samples 1-5 obtained from EXAMPLE 1-5 with 1 g for each material, were added to the 100 mL of groundwater solution A. After mixed, the groundwater solution A is adjusted to pH 1.5 by HCl, and reacted for 9 h under 150 C. After the reaction, solid and liquid are separated. Seven group solid and seven group groundwater solution A are collected, respectively.

The groundwater solution A before the reaction was prepared from real groundwater and reagents. The contaminants in the groundwater solution A before the reaction includes Cr(VI), As(V), Cd2+, mercury, nitrate, 2,4,6-trichlorophenol, methyl blue, bisphenol S and glyphosate. The concentration of contaminants in the groundwater solution A before and after reaction are shown in TABLE 3. [Among the contaminants, arsenic is a non-metallic element, which usually exists in the form of oxygen-containing anion (AsO43-) in water. It has the feature of heavy metals, so it is included in the scope of heavy metals in some tables.]

TABLE 3
Concentration of Contaminants in Groundwater Solution after Reaction in EXAMPLE 16

| | | | | | | 2,4,6- | | | |
|---|---|---|---|---|---|---|---|---|---|
| | Heavy Metals | | | | | trichloro- | Methyl | Bisphenol | Glypho- |
| | Cd²⁺ | As(V) | Cr(VI) | Hg | Nitrate | phenol | blue | S | sate |
| Contaminants | (mg/L) | (mg/L) | (mg/L) | (mg/L) | (mg/L) | (mg/L) | (mg/L) | (mg/L) | (mg/L) |
| Solution A | 20.05 | 20.33 | 19.87 | 5.03 | 24.93 | 19.88 | 20.11 | 20.36 | 24.55 |
| before | | | | | | | | | |
| reaction | | | | | | | | | |
| ZVI | 4.86 | <0.02 | 0.50 | <0.02 | 15.40 | 13.72 | <0.04 | 8.78 | <0.2 |
| Mg-Al LDH | 19.76 | 14.44 | 17.86 | 3.77 | 24.55 | 19.55 | 6.66 | 15.66 | 9.38 |
| Composite | <0.02 | <0.02 | <0.04 | <0.02 | <0.05 | 2.24 | <0.04 | 3.42 | <0.2 |
| material | | | | | | | | | |
| sample 1 | | | | | | | | | |
| Composite | <0.02 | <0.02 | <0.04 | <0.02 | <0.05 | 1.54 | <0.04 | 1.60 | <0.2 |
| material | | | | | | | | | |
| sample 2 | | | | | | | | | |
| Composite | <0.02 | <0.02 | <0.04 | <0.02 | <0.05 | 1.33 | <0.04 | 1.60 | <0.2 |
| material | | | | | | | | | |
| sample 3 | | | | | | | | | |
| Composite | <0.02 | <0.02 | <0.04 | <0.02 | <0.05 | 2.23 | <0.04 | 2.08 | <0.2 |
| material | | | | | | | | | |
| sample 4 | | | | | | | | | |
| Composite | <0.02 | <0.02 | <0.04 | <0.02 | <0.05 | 0.64 | <0.04 | 0.38 | <0.2 |
| material | | | | | | | | | |
| sample 5 | | | | | | | | | |

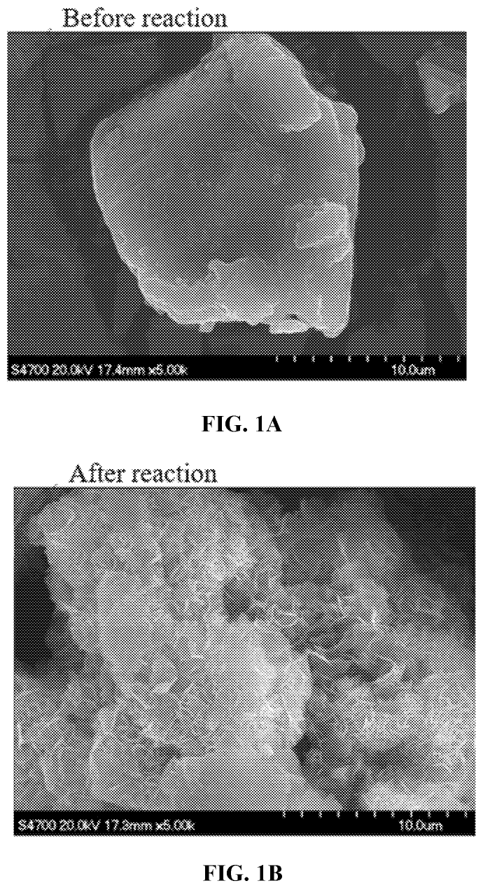

The SEM images of composite material sample 1 before the reaction and the reaction products obtained after the reaction are shown in FIG. 1A and FIG. 1B, respectively. It can be seen from FIG. 1 that the particle size of composite material sample 1 before the reaction is 0.02-2 mm, and the surface is flat and smooth, while the reaction products obtained after the reaction are typical platelet-like of LDH in shape.

By comparing the data in TABLE 3, the groundwater solution A including Cd2+, Cr(VI), As(V), mercury, nitrate nitrogen, 2,4,6-trichlorophenol, methyl blue, bisphenol S and glyphosate is treated with ZVI in 15° C. and initial pH 1.5. Among the contaminants, As(V), mercury, methyl blue and glyphosate are removed efficiently, but nitrate and chlorinated organic solvent (2,4,6-trichlorophenol) which is difficult to degrade are removed inefficiently, especially for nitrate. However, LDH only has effect on methyl blue and glyphosate removal in water, but it has almost no effect on organic solvents (2,4,6-trichlorophenol), endocrine disruptors (bisphenol S), heavy metals [Cd2+, Cr(VI), As(V), mercury] or nitrate. In comparison, composite material samples 1-5 prepared by the invention have good removal effects on heavy metals [Cd2+, Cr(VI), As(V), mercury], nitrate, methyl blue, bisphenol S, glyphosate removal in groundwater, especially for heavy metals and nitrate. The removal rate of nitrate, which is difficult to remove by both ZVI and LDH, is close to 100% by composite samples 1-5 in 15° C. at initial pH 1.5 after 9 h reaction.

### EXAMPLE 17

Take 1 g of composite material samples 6-10 obtained from EXAMPLE 6-10 and mix them into 100 mL groundwater solution B, and adjust the pH of mixed groundwater solution B to 6 by HCl. The reaction is carried out in 30° C. for 9 h. After the reaction, solid and liquid is separated, and five groups of solid after reaction are collected. five group solid and five group groundwater solution B are collected, respectively.

The groundwater solution B before the reaction was prepared from real groundwater and reagents. The contaminants in the groundwater solution B before the reaction includes Cu2+, Cd2+, Ni2+, Zn2+, As(V), Cr(VI), mercury, nitrate nitrogen, 2,4,6-trichlorophenol, methyl blue, bisphenol S and glyphosate. The concentration of contaminants in the groundwater solution B before and after reaction are shown in TABLE 4. [Among the contaminants, arsenic is a non-metallic element, which usually exists in the form of oxygen-containing anion (AsO43-) in water. It has the feature of heavy metals, so it is included in the scope of heavy metals in some tables.]

TABLE 4
Concentration of contaminants in groundwater solution before and after reaction in
EXAMPLE 17

| | | | | | | | | | 2,4,6- | | | |
|---|---|---|---|---|---|---|---|---|---|---|---|---|
| | Heavy metals | | | | | | | | trichloro- | Methyl | Bisphenol | Glypho- |
| | Cu²⁺ | Cd²⁺ | Ni²⁺ | Zn²⁺ | As(V) | Cr(VI) | Hg | Nitrate | phenol | blue | S | sate |
| Contaminants | (mg/L) | (mg/L) | (mg/L) | (mg/L) | (mg/L) | (mg/L) | (mg/L) | (mg/L) | (mg/L) | (mg/L) | (mg/L) | (mg/L) |
| Solution B before | 20.35 | 21.93 | 19.07 | 23.03 | 21.33 | 17.87 | 4.53 | 25.93 | 18.88 | 19.13 | 21.32 | 25.55 |
| reaction | | | | | | | | | | | | |
| Composite | <0.04 | <0.02 | <0.02 | <0.02 | <0.02 | 1.04 | <0.02 | 18.40 | 8.24 | <0.04 | 4.42 | <0.2 |
| material sample 6 | | | | | | | | | | | | |
| Composite | <0.04 | <0.02 | <0.02 | <0.02 | <0.02 | 3.99 | <0.02 | 15.23 | 7.54 | <0.04 | 4.47 | <0.2 |
| material sample 7 | | | | | | | | | | | | |
| Composite | <0.04 | <0.02 | <0.02 | <0.02 | <0.02 | 0.84 | <0.02 | 10.05 | 2.24 | <0.04 | 2.42 | <0.2 |
| material sample 8 | | | | | | | | | | | | |
| Composite | <0.04 | <0.02 | <0.02 | <0.02 | <0.02 | 5.89 | <0.02 | 12.77 | 2.54 | <0.04 | 2.60 | <0.2 |
| material sample 9 | | | | | | | | | | | | |
| Composite | <0.04 | <0.02 | <0.02 | <0.02 | <0.02 | 1.02 | <0.02 | 8.05 | 1.64 | <0.04 | 1.38 | <0.2 |
| material sample | | | | | | | | | | | | |
| 10 | | | | | | | | | | | | |

### Example 18

Take 1 g of composite material samples 11-15 obtained from EXAMPLE 11-15, and mix them into 100 mL groundwater solution C, and adjust the pH of mixed groundwater solution C to 10 by NaOH. The reaction is carried out in 45° C. for 9 h. After the reaction, solid and liquid is separated, and five groups of solid after reaction are collected. five group solid and five group groundwater solution B are collected, respectively.

The groundwater solution C before the reaction was prepared from real groundwater and reagents. The contaminants in the groundwater solution C before the reaction includes Cr(VI), As(V), mercury, nitrate, 2,4,6-trichlorophenol, methyl blue, bisphenol S and glyphosate. The concentration of contaminants in the groundwater solution B before and after reaction are shown in TABLE 4. Because heavy metal cations form precipitation under alkaline conditions, the contaminants in water before reaction do not include heavy metal cations. [Among the contaminants, arsenic is a non-metallic element, which usually exists in the form of oxygen-containing anion (AsO43-) in water. It has the feature of heavy metals, so it is included in the scope of heavy metals (similar to lead) in some tables.]

TABLE 5
Concentration of Contaminants in Groundwater Solution before and after Reaction in
EXAMPLE 18

| | Heavy metals | | | 2,4,6- | Methyl | Bisphenol | |
|---|---|---|---|---|---|---|---|
| | As(V) | Cr(VI) | Nitrate | Trichlorophenol | blue | S | Glyphosate |
| Contaminants | (mg/L) | (mg/L) | (mg/L) | (mg/L) | (mg/L) | (mg/L) | (mg/L) |
| Solution C before | 10.99 | 9.78 | 25.03 | 10.04 | 10.09 | 11.33 | 10.28 |
| reaction | | | | | | | |
| Composite material | <0.02 | 4.03 | 22.05 | 6.84 | <0.04 | 7.41 | <0.2 |
| sample 11 | | | | | | | |
| Composite material | <0.02 | 5.91 | 22.53 | 6.94 | <0.04 | 7.46 | <0.2 |
| sample 12 | | | | | | | |
| Composite material | <0.02 | 3.02 | 20.85 | 5.24 | <0.04 | 5.42 | <0.2 |
| sample 13 | | | | | | | |
| Composite material | <0.02 | 6.87 | 22.97 | 6.98 | <0.04 | 8.00 | <0.2 |
| sample 14 | | | | | | | |
| Composite material | <0.02 | 3.05 | 17.05 | 5.64 | <0.04 | 5.38 | <0.2 |
| sample 15 | | | | | | | |

As demonstrated in TABLES 3, 4 and 5, no matter elemental aluminum or aluminum calcium, aluminum magnesium, aluminum iron, aluminum, aluminum zinc, aluminum nickel, aluminum manganese, aluminum silicon alloy are the aluminum source; no matter elemental calcium, magnesium, iron, zinc, nickel, manganese, or alloy composed two or three from calcium, magnesium, iron, zinc, nickel, manganese are the second metal source; no matter composite material samples 1-5 prepared by the first method or composite material samples 6-15 prepared by the second method have a good removal effect on organic dyes (methyl blue), heavy metals [Cu2+, Cd2+, Zn2+, Ni2+, Cr(VI), As(V)], chlorinated organic solvents (2,4,6-trichlorophenol), endocrine disruptors (bisphenol S), nitrate and pesticide residues (glyphosate) in groundwater, and have a wide range of applications, especially for the nitrate which is difficult to remove by ZVI in existing technology.

Furthermore, based on the data in TABLES 3, 4 and 5, no matter under the acidic with initial pH 1.5 and low temperature of 15° C., or under the nearly neutral condition with initial pH 6 and temperature of 30° C., or under the alkaline with initial pH 10 and high temperature of 45° C., the composite material sample 1-15 prepared by the invention have the removal effect on organic dyes (methyl blue), heavy metals [Cu2+, Cd2+, Zn2+, Ni2+, Cr(VI), As(V)], chlorinated organic solvents (2,4,6-trichlorophenol), endocrine disruptors (bisphenol S), nitrate and pesticide residues (glyphosate) in groundwater. The suitable pH range is wide. The remediation process is mild, that is, the composite material slowly dissolves all kinds of ions during reaction. Compared with parts of the existing technology carried out under alkaline conditions, this material avoids the direct dumping of alkali into the actual water body, high alkali situation in local water body and harm to aquatic ecosystem. In addition, based on the data in TABLES 3, 4 and 5, with the increase of pH, removal efficiency of chlorinated organic solvents (2,4,6-trichlorophenol) and nitrate by composite materials decline slightly. Especially, nitrate can be removed by composite material samples prepared by the invention at initial pH 10, but the removal effect is not good. Thus, the invention is especially suitable for highly acidic contaminated water bodies. For highly acidic contaminated water bodies, not only a variety of contaminants are removed, but also the pH value of treated water bodies is stable at 8-9 without additional alkali, which meets water quality standards. However, the conventional water treatment process to remediate acidic wastewater usually requires additional alkali to neutralize the acid in the water, and the control requirement of the alkali amount is extremely demanding. The pH value can easily exceed the pH value of the water standard under inaccurate control.

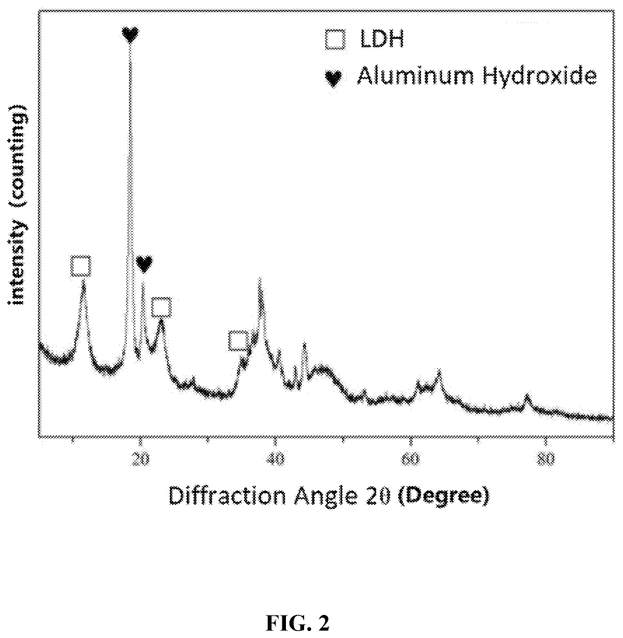

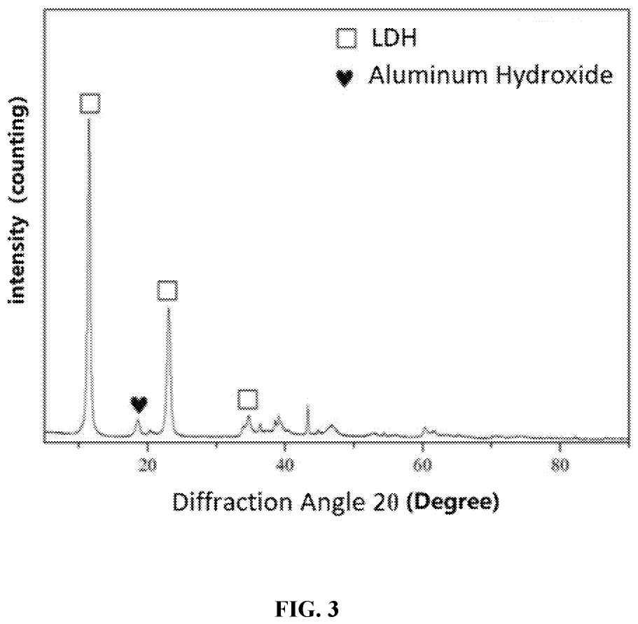

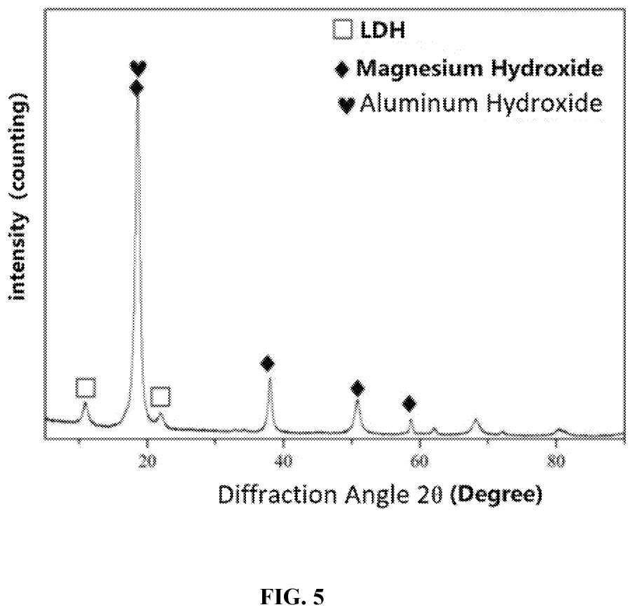

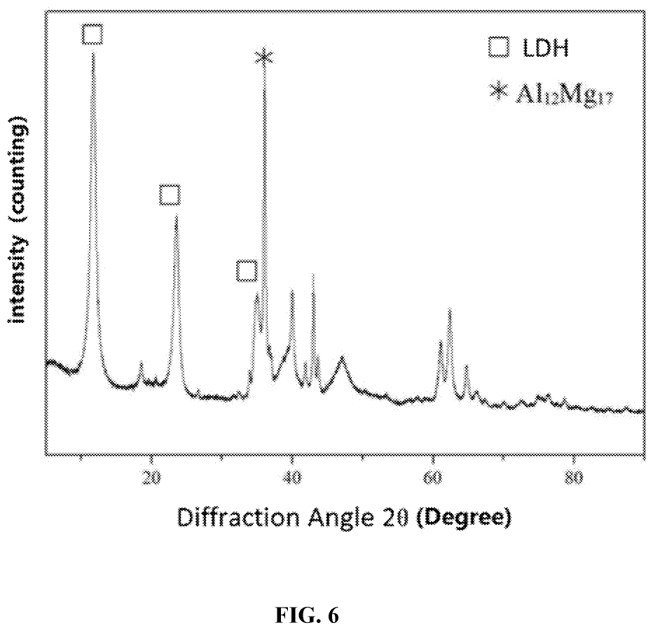

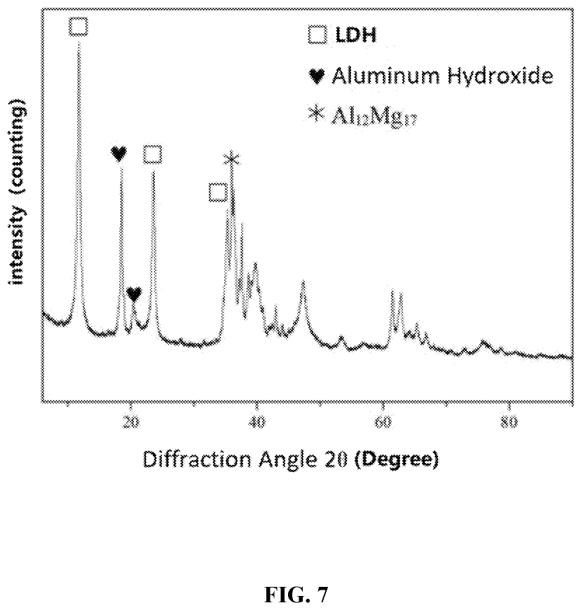

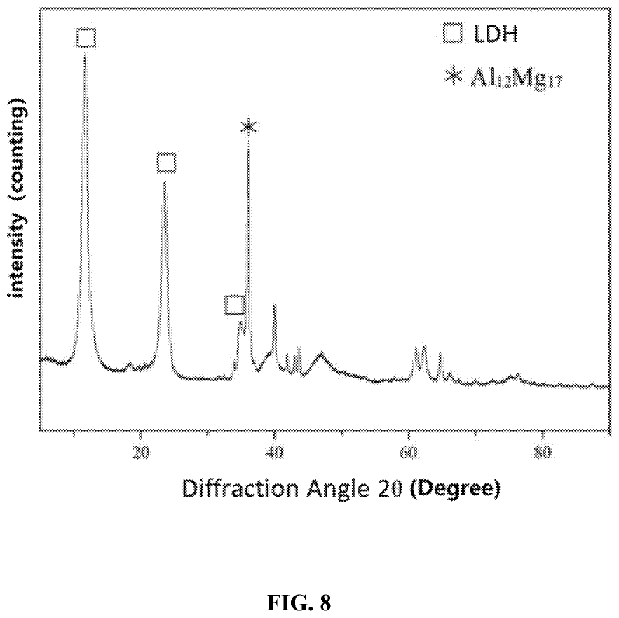

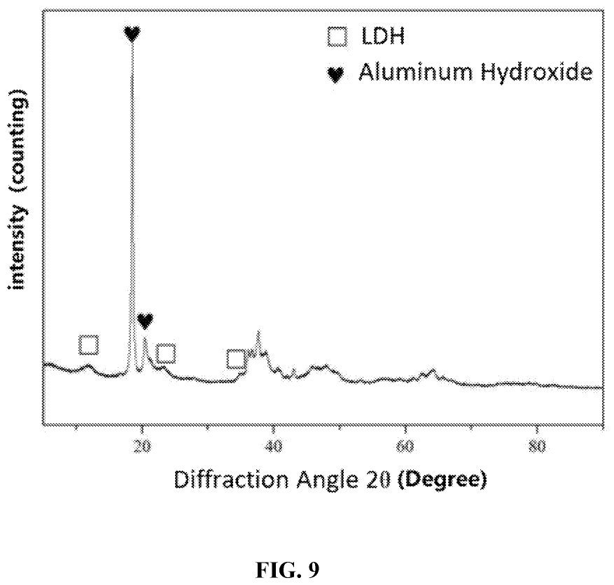

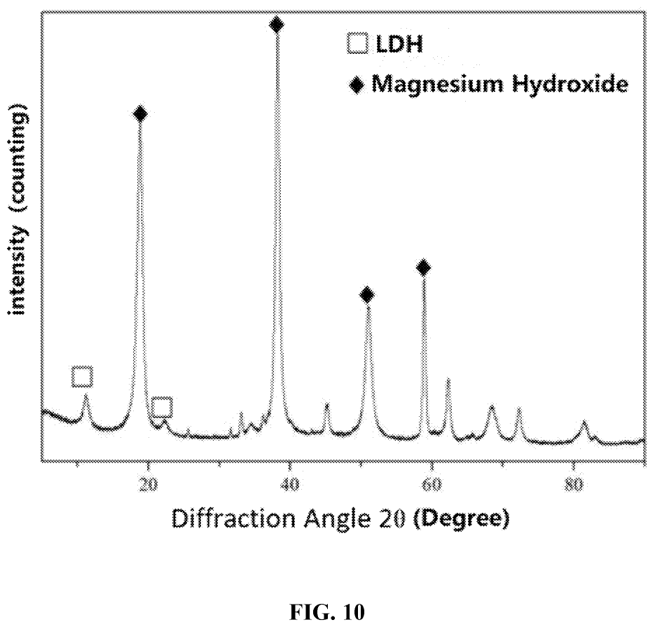

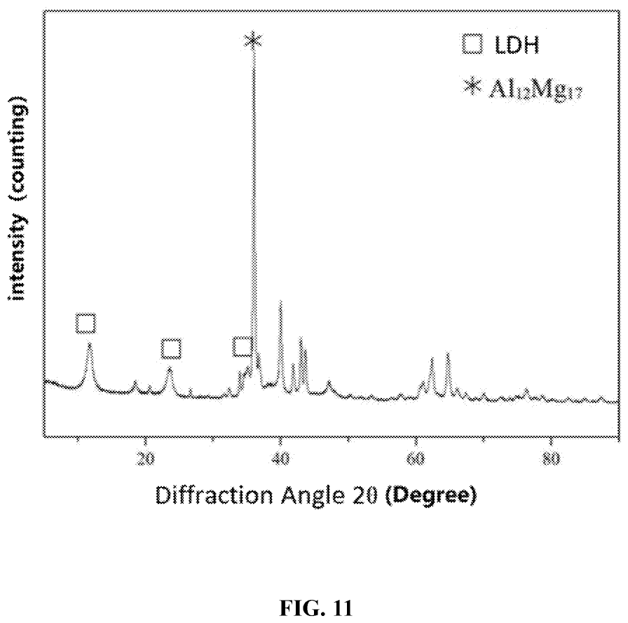

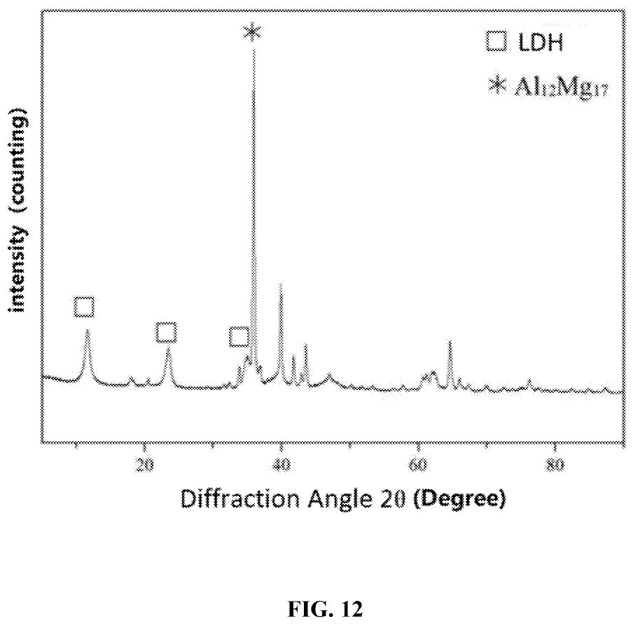

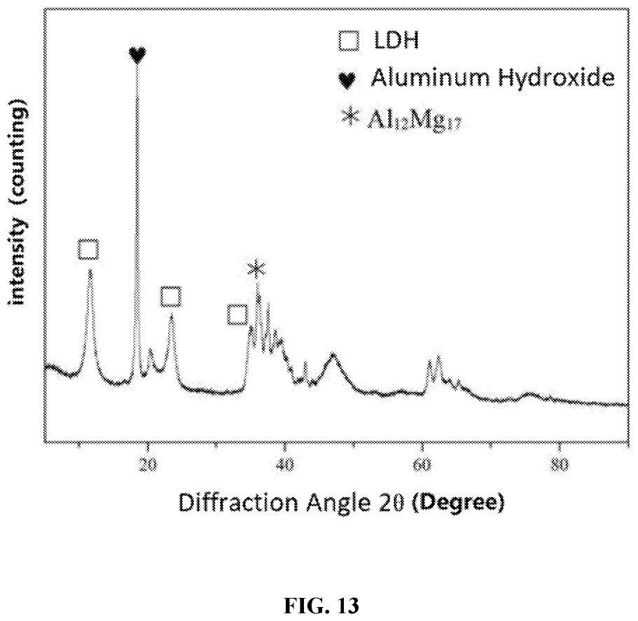

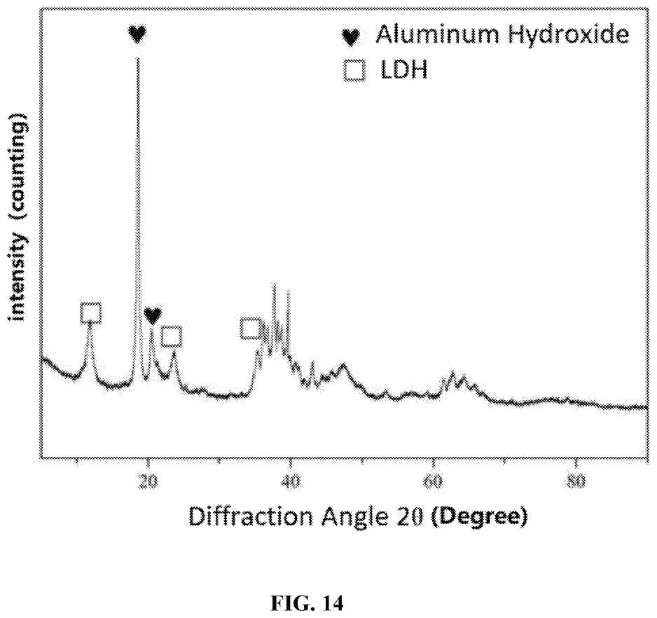

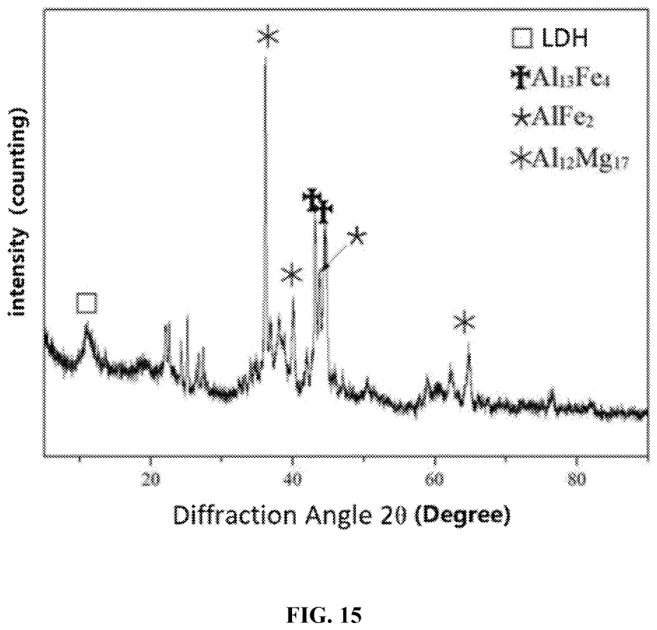

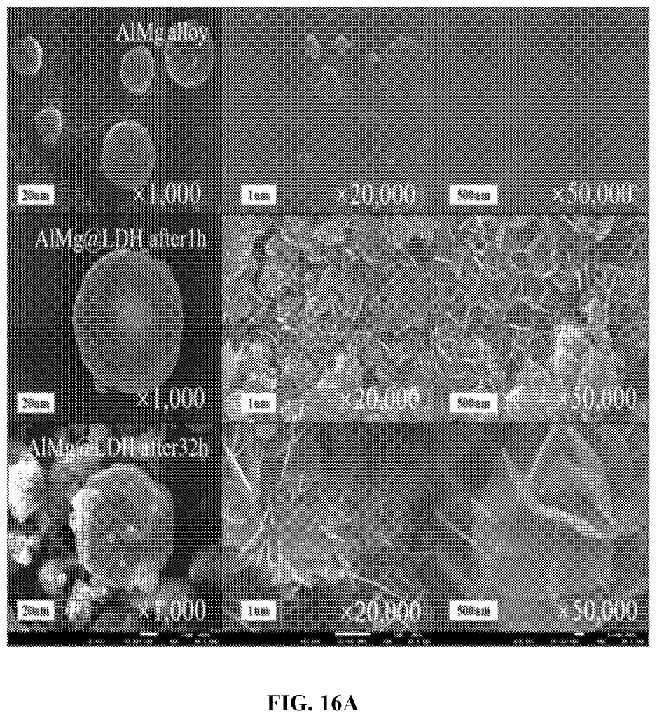

The reaction products from composite materials 1-15 after pollutants removal are characterized by XRD and the results are shown in FIG. 2-FIG. 15. The characteristic peaks of LDH indicate that LDH is generated from composite materials 1-15 after the removal process and this is in agreement with the SEM results of FIG. 1. In another words, a REDOX reaction has occurred when the composite materials are exposed to the contaminated water; the reaction releases divalent metal ions, trivalent aluminum ions and hydroxide ions, which, together with other divalent and trivalent metal cations and anions present in the contaminated water, self-assembly in situ to form the precipitates of two-dimensional layered double hydroxides (LDH), which further adsorbs and catalyzes degradation of organic contaminants in water.

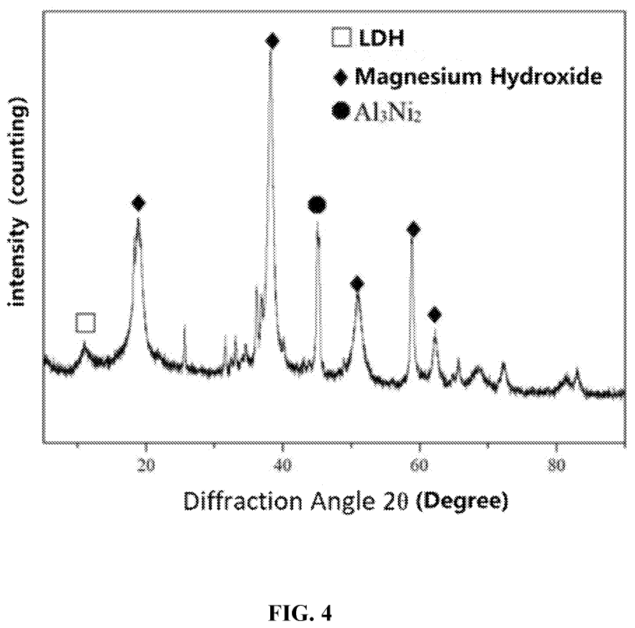

On the other hand, both composites prepared by the two methods produce LDH after reacting with contaminated water, which is caused by the combination of ions dissolved from reaction of the alloy with contaminated water, and anions in the water, as mentioned previously. When the aluminum content in the material is high, the product includes aluminum hydroxide, which is due to the high concentration of trivalent aluminum ions and the low concentration of divalent metal ions in the solution are not meet the optimal conditions for LDH preparation (molar ratio of divalent metal ions to trivalent metal ions between 1:4). Some XRD (FIG. 4, 6-8, 11-13, 15) patterns show unreacted alloy phases, such as Al12Mg17, which resulted from the short reaction time and incomplete reaction.

### Further Invention

CN102583659 discloses an acid-base dual-purpose Fe—Al—C microelectrolytic filler, which is prepared by mixing iron, aluminum and graphite powders in a mass ratio (2-6): (2-6): 1. Graphite powers are not one of the components used in the present invention and the mass ratio of iron powder, aluminum powder and graphite powder of CN102583659 is obviously different from those of aluminum, second type metal and the auxiliary agent in the present invention. Fe is the core metal of the components and Al is the second metal in CN102583659 while Al is the core metal and the auxiliary agent is not essential. The technical core concept of the present invention is that the metal components provide electrons for chemical degradation of pollutants and the released divalent and trivalent metal ions self-assembly in situ into Layered Double Hydroxide (LDH). LDH is a general term for Hydrotalcite (HT) and hydrotalcite-like Compounds (HTLCs) and may be transformed into a series of supramolecular materials by intercalation of many other inorganic and organic compounds.

In another example of the invention, prior to use, the composite alloy materials are pretreated by dilute HCl to coat a thin film of LDH on the surface of the alloy particles achieving micro-nano composite with core-shell structures Alloy@LDH. The as-prepared core-shell materials present more efficient remediation.

In a further example according to the invention, composite material composed of an aluminum source and/or a second type of metal source and LDH.

In a further example according to the invention, composite material composed of an aluminum source and/or a second type of metal source, hydrotalcite and auxiliary agent.

Preferably, as the composite material with porous surface structure of the invention, there is of 20 μm-2 mm of particle size and 3-50 m²/g of a specific surface area.

In examples for soil remediation of the invention, achieved beneficial technical effects include that:
1) nitrate is converted into ammonium (ammonium ion), which can be easily adsorbed on the surface of soil colloids, and can also enter a lattice of clay minerals to become fixed ammonium ions, or converted into guano stone to reduce a loss of ammonia and increase effect of nitrogen fixation;
2) increase soil magnesium fertility and beneficial microelement contents to improve soil pH buffer capacity;
3) regulate soil microbial community to promote soil biodiversity;
4) regulate soil porosity, air permeability, and water retention to promote plant growth;
5) for acid sewage, the invention improves a contaminants removal rate and efficiency with a slow release performance and durability;
6) ability to fix and remove heavy metals and other non-metallic contaminants (heavy metals, pesticides, herbicides, antibiotics, dyes, emerging organic pollutants and other complex contaminants) can be greatly improved.

The above advantages of the invention can be confirmed by the following experimental results.

The experimental equipment and measuring apparatus adopted in the invention include oscillator, batch reactor, a toxicity test leaching and measuring cylinder, a volumetric flask and an analytical balance.

The equipment for measuring concentration of contaminants before and after the experiment includes ICP-OES, ICP-MS, LC-MS, GC, HPLC, GC-MS and UV-Vis.

FIG. 2-FIG. 15 show XRD characterization of the reaction products of the composite materials invented in this application with contaminated water, indicating that all of the reaction products contain a certain amount of LDH, featured by the peaks at the diffraction angles 20 of xx, xx and xx representing the crystal planes of (xxx), (x×x) and (x×x), respectively. For example, 11.6°, 23.4° and 34.9° representing the crystal planes of (003), (006) and (009), respectively.

The products are composites of the alloy, intermetallic compounds such as A13Ni2, Al12Mg17, AlFe2, Al13Fe4 depending on the alloying metals with Al and the concentration of the alloying metals. The composites of intermetallic compounds and LDH catalyze the transformation of metal species (e.g., chemical reduction of heavy metal ions to zerovalent) and chemical degradation of organic pollutants.

TABLE 6
The concentration in mg/L of the contaminants and final pH of the groundwater sample
treated by composite material 6 in TABLE 2 at initial pH 1.5-6.5 and by ZVI at initial pH 1.5.

| | | | | | | | 4- | | | pH |
|---|---|---|---|---|---|---|---|---|---|---|
| | | | | | | | Chloro- | Bisphenol | | after |
| | Cd | Cr(VI) | Ni | As | Al | Fe | phenol | S | Glyphosate | reaction |
| Original | 10 | 50 | 20 | 10 | 1.0 | 150 | 20 | 20 | 20 | — |
| groundwater | | | | | | | | | | |
| Initial pH 1.5 | <0.01 | <0.02 | <0.05 | <0.02 | <0.1 | <0.2 | <0.5 | <0.5 | <0.5 | 8.3 |
| Initial pH 3.0 | <0.01 | <0.02 | <0.05 | <0.02 | <0.1 | <0.2 | <0.5 | <0.5 | <0.5 | 8.7 |
| Initial pH 5.0 | <0.01 | <0.02 | <0.05 | <0.02 | <0.1 | <0.2 | <0.5 | <0.5 | <0.5 | 8.5 |
| Initial pH 6.5 | <0.01 | <0.02 | <0.05 | <0.02 | <0.1 | <0.2 | <0.5 | <0.5 | <0.5 | 8.4 |
| ZVI pH 1.5 | 2.3 | <0.02 | 4.6 | <0.02 | <0.1 | 350 | <0.5 | <0.5 | <0.5 | 4.2 |

Note:
ZVI = zerovalent iron;
the pH of the groundwater sample is adjusted to 1.5-6.5 and the sample is spiked with Cd, Cr(VI), Ni, As, 4-chlorophenol, bisphenol S and glyphosate in mixtures.

TABLE 6 demonstrate that the concentrations of 10-50 mg/L Cd, Cr(VI), Ni, As, 4-chlorophenol, bisphenol S and glyphosate spiked in a real groundwater are all reduced to <0.1-0.5 mg/L by composite material 6, achieving removal efficiencies of >97.5-99.96% and the concentrations of Al and Fe are reduced to <0.1 and <0.2 mg/L from 1.0 and 150 mg/L, respectively; the final pH is between 8.3 and 8.7. By contrast, the ZVI treatment presents poor efficiencies for Cd (from 10 to 2.3 mg/L, i.e., 77% removal), Ni (from 20 to 4.6 mg/L, i.e., 77% removal), causes a secondary contamination by Fe (from 150 to 350 mg/L) and does not bring the pH to a required pH range of 6-9 to meet the guideline of groundwater. Clearly, the composite material invented in this application is superior to ZVI in water treatment and purification and this is attributed to the redox reactivity of the composite material and in situ generation of hybrid LDH.

TABLE 7
The concentration in mg/L of the contaminants and final pH of the
groundwater sample treated by composite material 8 in
TABLE 2 at initial pH 7.5-11.5 and by ZVI at initial pH 7.5.

| | | 4- | Bisphenol | | pH after |
|---|---|---|---|---|---|
| | Cr(VI) | Chlorophenol | S | Glyphosate | reaction |
| Original | 50 | 20 | 20 | 20 | |
| groundwater | | | | | |
| Initial pH 7.5 | <0.05 | <0.5 | <0.5 | <0.5 | 8.4 |
| Initial pH 10.0 | <0.05 | <0.5 | <0.5 | <0.5 | 9.3 |
| Initial pH 11.5 | <0.05 | <0.5 | <0.5 | <0.5 | 9.6 |
| ZVI pH 7.5 | 30 | 18 | 19 | 16 | 8.5 |

Note:
ZVI = zerovalent iron.

The demonstration experiment in TABLE 7 investigates the removal of Cr(VI), 4-chlorophenol, bisphenol S and glyphosate by composite material 8 at initial pH of 7.5-11.5 and by ZVI at pH 7.5. The results indicate that ZVI is almost not effective while the composite material invented in this application is highly efficient to remove the contaminants at alkaline pH conditions. TABLES 8, 9 and 10 present comparisons of the invented composite material with ZVI at pH 3 and reaction temperatures of 7-28° C., reaction times of 6-15 h and dosages of 0.5-20 g/L, respectively. In all cases, the invented composite materials outperform ZVI in the removal efficiency and secondary contamination. The excellent performance comes from the reactivity of the composite material and in situ LDH.

TABLE 8
Concentration (mg/L) of contaminants and final pH of the groundwater sample treated
by composite material 10 in TABLE 2 at the reaction temperature of 7-28° C. and pH 3.0 and by
ZVI at 25° C. and pH 3.0.

| | | | | | | | 4- | Bisphenol | | pH after |
|---|---|---|---|---|---|---|---|---|---|---|
| | Cd | Cr(VI) | Ni | As | Al | Fe | Chlorophenol | S | Glyphosate | reaction |
| Original | 10 | 50 | 20 | 10 | 1.0 | 150 | 20 | 20 | 20 | — |
| groundwater | | | | | | | | | | |
| pH 3.0 | | | | | | | | | | |
| Reaction | <0.01 | <0.02 | <0.05 | <0.02 | <0.1 | <0.2 | <0.5 | <0.5 | <0.5 | 8.3 |
| temperature | | | | | | | | | | |
| 7° C. | | | | | | | | | | |
| Reaction | <0.01 | <0.02 | <0.05 | <0.02 | <0.1 | <0.2 | <0.5 | <0.5 | <0.5 | 8.7 |
| temperature | | | | | | | | | | |
| 15° C. | | | | | | | | | | |
| Reaction | <0.01 | <0.02 | <0.05 | <0.02 | <0.1 | <0.2 | <0.5 | <0.5 | <0.5 | 8.5 |
| temperature | | | | | | | | | | |
| 22° C. | | | | | | | | | | |
| Reaction | <0.01 | <0.02 | <0.05 | <0.02 | <0.1 | <0.2 | <0.5 | <0.5 | <0.5 | 8.4 |
| temperature | | | | | | | | | | |
| 25° C. | | | | | | | | | | |
| Reaction | <0.01 | <0.02 | <0.05 | <0.02 | <0.1 | <0.2 | <0.5 | <0.5 | <0.5 | 8.8 |
| temperature | | | | | | | | | | |
| 28° C. | | | | | | | | | | |
| ZVI | 3.1 | <0.02 | 4.3 | <0.02 | <0.1 | 190 | <0.5 | <0.5 | <0.5 | 4.3 |
| Reaction | | | | | | | | | | |
| temperature | | | | | | | | | | |
| 25° C. | | | | | | | | | | |

Note:
ZVI = zerovalent iron

TABLE 9
The concentration in mg/L of the contaminants and final pH of the groundwater sample
treated by composite material 11 in TABLE 2 at pH 3.0 and in different reaction times of 6-15 h
and by ZVI in 15 h.

| | | | | | | | 4- | Bisphenol | | pH after |
|---|---|---|---|---|---|---|---|---|---|---|
| | Cd | Cr(VI) | Ni | As | Al | Fe | Chlorophenol | S | Glyphosate | reaction |
| Original | 10 | 50 | 20 | 10 | 1.0 | 150 | 20 | 20 | 20 | — |
| groundwater | | | | | | | | | | |
| pH 3.0 | | | | | | | | | | |
| Reaction | <0.01 | <0.02 | <0.05 | <0.02 | <01 | <0.2 | <0.5 | <0.5 | <0.5 | 8.1 |
| time 6 h | | | | | | | | | | |
| Reaction | <0.01 | <0.02 | <0.05 | <0.02 | <0.1 | <0.2 | <0.5 | <0.5 | <0.5 | 8.6 |
| time 9 h | | | | | | | | | | |
| Reaction | <0.01 | <0.02 | <0.05 | <0.02 | <0.1 | <0.2 | <0.5 | <0.5 | <0.5 | 8.7 |
| time 12 h | | | | | | | | | | |
| Reaction | <0.01 | <0.02 | <0.05 | <0.02 | <0.1 | <0.2 | <0.5 | <0.5 | <0.5 | 8.9 |
| time 15 h | | | | | | | | | | |
| ZVI | 3.9 | <0.02 | 5.3 | <0.02 | <0.1 | 210 | <0.5 | <0.5 | <0.5 | 4.5 |
| Reaction | | | | | | | | | | |
| time 15 h | | | | | | | | | | |

Note:
ZVI = zerovalent iron

TABLE 10
The concentration in mg/L of the contaminants and final pH of the groundwater sample
treated by composite material 12 in TABLE 2 at pH 3.0 and in different dosages of 0.5-20 g/L
and by ZVI of 20 g/L.

| | | | | | | | 4- | Bisphenol | | pH after |
|---|---|---|---|---|---|---|---|---|---|---|
| | Cd | Cr(VI) | Ni | As | Al | Fe | Chlorophenol | S | Glyphosate | reaction |
| Original | 10 | 50 | 20 | 10 | 1.0 | 15 | 20 | 20 | 20 | |
| groundwater | | | | | | 0 | | | | |
| Loading | <0.01 | <0.02 | <0.05 | <0.02 | <0.1 | <0.2 | <0.5 | <0.5 | <0.5 | 7.9 |
| 0.5 g/L | | | | | | | | | | |
| Loading | <0.01 | <0.02 | <0.05 | <0.02 | <0.1 | <0.2 | <0.5 | <0.5 | <0.5 | 8.3 |
| 1 g/L | | | | | | | | | | |
| Loading | <0.01 | <0.02 | <0.05 | <0.02 | <0.1 | <0.2 | <0.5 | <0.5 | <0.5 | 8.6 |
| 10 g/L | | | | | | | | | | |
| Loading | <0.01 | <0.02 | <0.05 | <0.02 | <0.1 | <0.2 | <0.5 | <0.5 | <0.5 | 9.3 |
| 20 g/L | | | | | | | | | | |
| ZVI | 2.9 | <0.02 | 4.4 | <0.02 | <0.1 | 290 | <0.5 | <0.5 | <0.5 | 4.2 |
| Loading | | | | | | | | | | |
| 20 g/L | | | | | | | | | | |

Note:
ZVI = zerovalent iron

### The Inventive Concept of “Al—Mg Alloy In Situ LDH” is Firstly Proposed in the Present Application

Groundwater remediation has been focusing on the development of nanocomposite materials by combining nZVI with AC or other carbon materials to take the advantages of chemical degradation and adsorption. For example, a Carbo-Iron®, being registered as a trademark in Germany and consisting of nZVI clusters on activated carbon colloids (ACC) has been developed. The composite material is especially designed for the in situ generation of reactive zones and contaminant source removal when applied in groundwater remediation processes. Although nZVI-AC composite materials avoid fast aggregation and agglomeration of nZVI, the reactivity of nZVI and the adsorption capacity of AC in the nZVI-AC nanocomposites are deteriorated. Furthermore, the complicated reparation procedures, high cost, limited lifespan and ecotoxicity of nanomaterials are major limitations for these types of composite materials in the field applications.

Both Mg and Al are active metals but they are not applicable in groundwater remediation mainly because Mg metal is such reactive that it reacts rapidly with water while the passivation of Al metal makes it inertness in the most cases of groundwater conditions. Mg and Al alloys have been widely and extensively applied in many fields but they have not been applied in environmental remediation yet. The present invention is to adjust the reactivities of Mg and Al by alloying (the principle is not new) to fit into water and groundwater remediation by physiochemical and redox reactions through the reactivities of Mg—Al alloys to chemically degrade the pollutants and the adsorption, ion-exchange, surface complexation, isomorphous substitution and intercalation of in situ layered double hydroxides (LDH) to remove the primary and secondary contaminants from water (this principle is NEW). Particular Al—Mg alloys are fabricated such that the alloys provide the electrons for the chemical reduction and/or the degradation of pollutants while released Mg2+, Al3+ and OH-ions react to generate in situ LDH precipitates, incorporating other divalent and trivalent metals and oxyanions pollutants and further adsorbing the micropollutants.

### Pretreatment to Coat a Thin Film of LDH on a Surface of Alloys

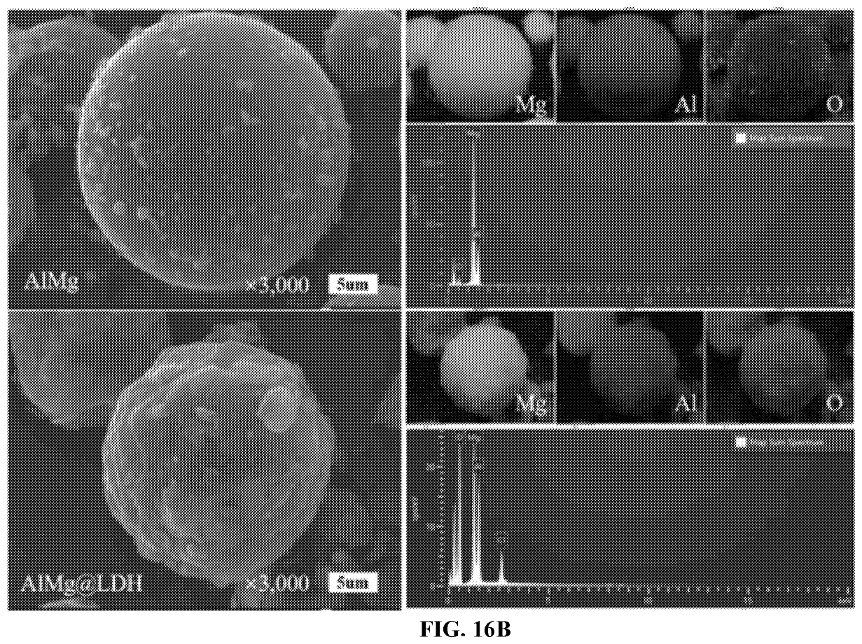

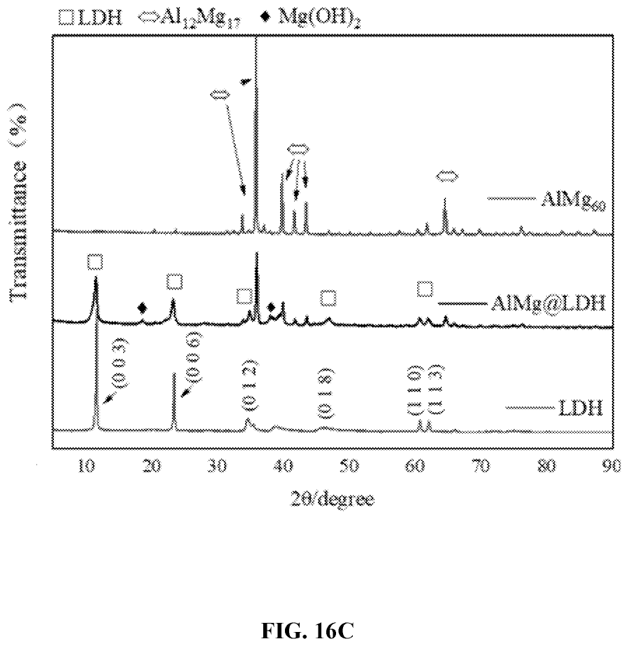

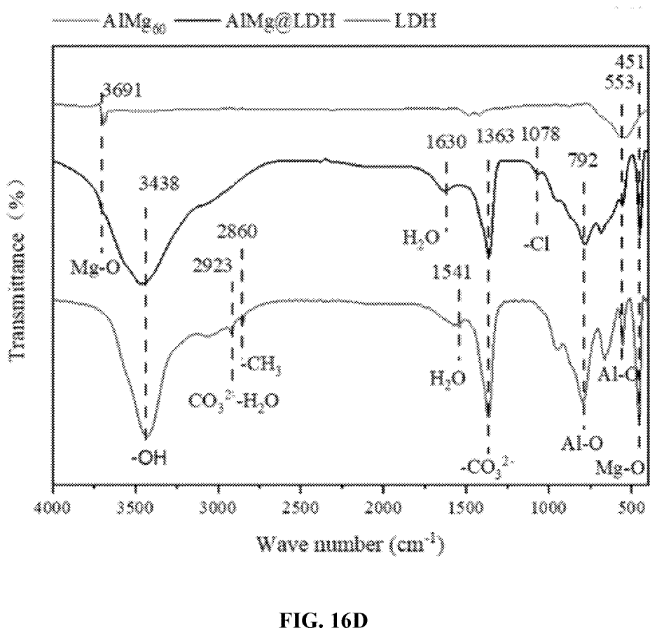

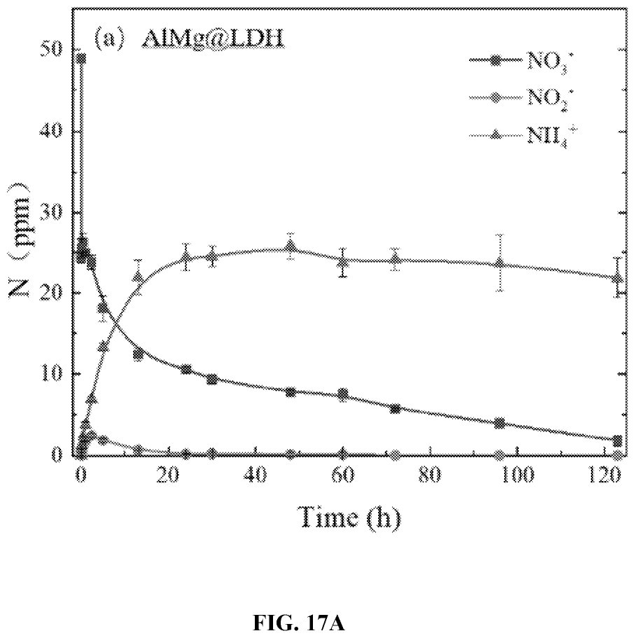

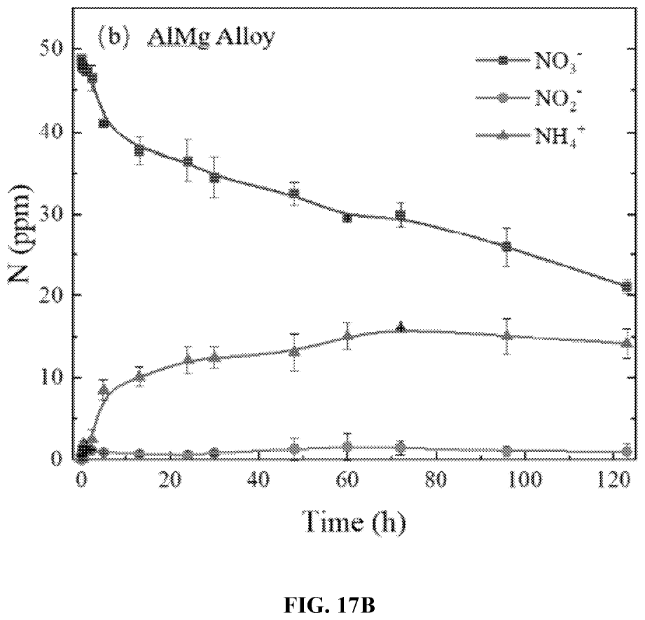

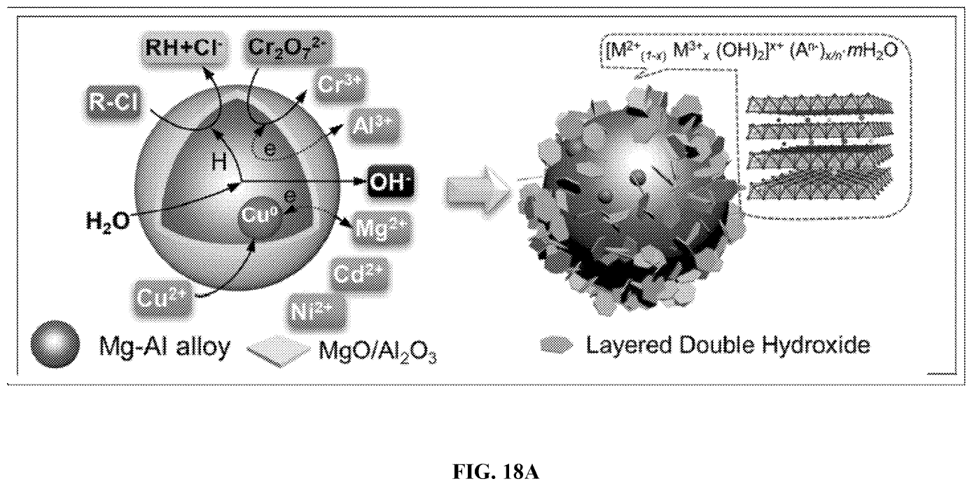

A thin film/layer of LDH is coated on the surface of the alloy particles to fabricate core/shell structures of composite material Al—Mg@LDH (FIG. 16A, FIG. 16B, FIG. 16C, and FIG. 16D) by pretreating the alloy particles with dilute HCl pH 1-2. The chemical conversion/transformation of pollutants is significantly facilitated by the LDH pre-coated alloys. For example, the rate of nitrate chemical reduction in 10 h is improved by 3 folds using Al—Mg@LDH (FIG. 17A, FIG. 17B).

### Merits of the Invention

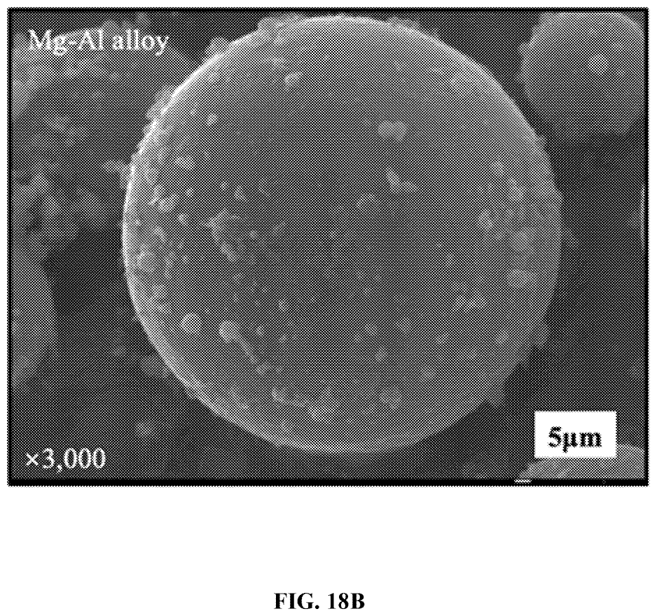

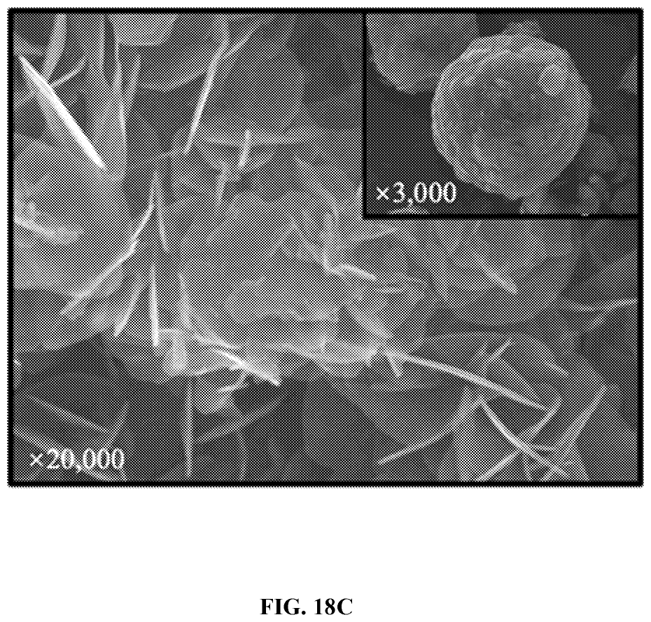

Al and Mg are amphoteric metals such that they are active in acidic and alkaline pH conditions, i.e., they readily provide electrons to pollutants in acidic and alkaline environments. In general, the formation of LDH is a slow process, which requires a timeframe of hours and days depending on the reaction conditions (temperature, metal ions concentration and ratio and aqueous pH). By contrast, iron oxides and ferric hydroxide precipitation occurs instantly on the surface of ZVI and nZVI upon the release of Fe2+ at pH above 3.5 and this is the root cause for the passivation of ZVI and nZVI. As such, the surface of Al—Mg alloys is in a continuing renewal via in situ assembly of LDH, a typical molecular formular of which is M6Al2(OH)16CO3·4H2O where M is divalent metal ions, which are the reaction product of the alloy with water and pollutants, and are present in the original water. LDH is highly capable of removing a wide variety of micropollutants (metals, inorganic and organics) by adsorption, ion-exchange, surface complexation, isomorphous substitution and intercalation and chemical catalytic degradation. As such, those pollutants which are not removable by the redox reaction with Al—Mg alloys and the secondary pollutants can be both removed by the in situ LDH (FIG. 18A, FIG. 18B, and FIG. 18C). Consequently, the performance of water remediation is significantly improved by a synergistic effect of Al—Mg alloy and in situ LDH in terms of the pollutant removal efficiency, capability and capacity. In summary, microscale Al—Mg alloy and Al—Mg@LDH particles outperform nanoscale ZVI (nZVI) in water remediation by
1) significantly improving the rheology, mobility and dispersity of the water-remediation material slurry;
2) enabling effective and efficient removal of complex chemical mixtures and a wide variety of pollutants from a wide range of pH environment from acidic to alkaline pH;
3) eliminating secondary contamination and being environmentally benign as LDH is a natural clay.

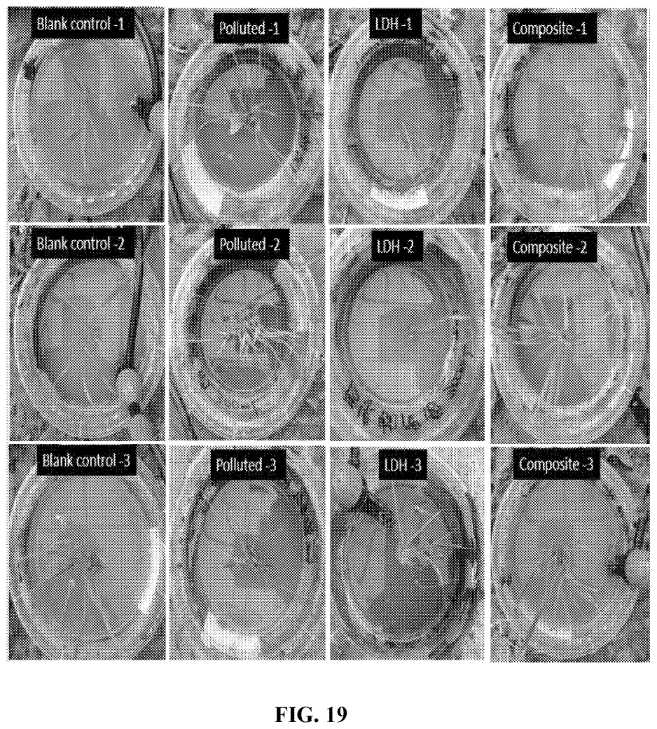

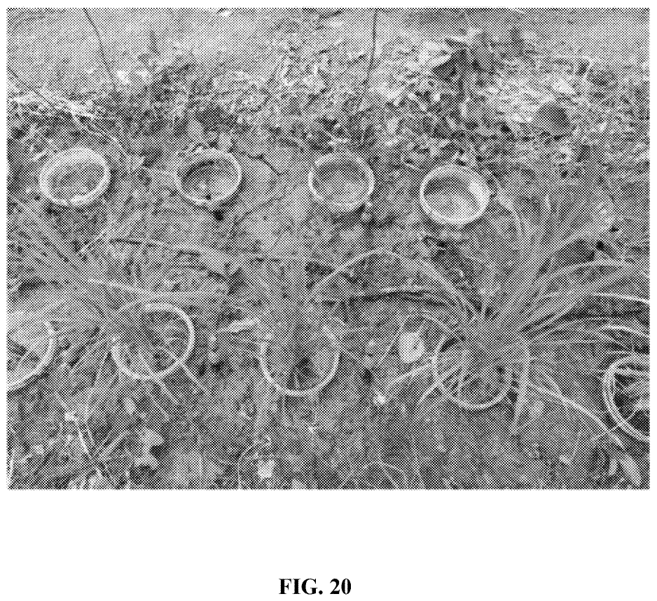

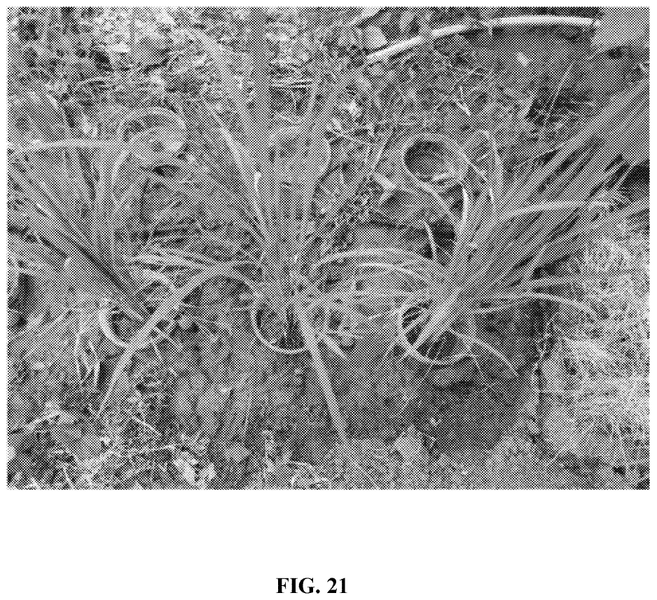

The super-performance of Al—Mg alloys and in situ LDH is further demonstrated by remediating soils contaminated with 2000 mg/kg Ni2+ and 200 mg/kg Bisphenol S. The rice cultivars die in the polluted soils without remediation and added with commercially available LDH at a dosage of 1000 mg/kg soil. By contrast, the rice cultivars are alive and growing well in the unpolluted soils and polluted soils with composite material at the dosage of 1000 mg/kg soil (FIG. 19, FIG. 20 and FIG. 21).

Extra-Examples 1-5 prepared composite materials using different element ratios. The specific element ratios are shown in Extra-Table 1. The preparation method of melt atomization followed by mechanical ball milling was used.

Extra-Table 1: Element Ratios for Extra-Examples 1-5

| | Mg/Al ratio | Ca | Fe | Cu | Zn | B | La | Mo | Mn | Si |
|---|---|---|---|---|---|---|---|---|---|---|
| Extra-Example 1 | 3:1 | 0.5 | 0 | 0.05 | 0 | 0.05 | 0.05 | 0.05 | 0 | 0.1 |
| Extra-Example 2 | 3:1 | 1.5 | 1.0 | 0.5 | 1.0 | 0.4 | 0.5 | 0.1 | 1.0 | 1.0 |
| Extra-Example 3 | 3:1 | 0.75 | 0.5 | 0.25 | 0.5 | 0.2 | 0.25 | 0.05 | 0.5 | 0.5 |
| Extra-Example 4 | 1:1 | 0.75 | 0.5 | 0.25 | 0.5 | 0.2 | 0.25 | 0.05 | 0.5 | 0.5 |
| Extra-Example 5 | 6:1 | 0.75 | 0.5 | 0.25 | 0.5 | 0.2 | 0.25 | 0.05 | 0.5 | 0.5 |

The composite materials prepared in Extra-Examples 1-5 were applied to contaminated soil with a cadmium concentration of 5.38 mg/kg by rotary tillage. The cadmium content in rice and quality results are shown in Extra-Table 2.

EXTRA-TABLE 2
Rice Cd Content and Yield of Extra-Examples 1-5

| | Cd Content in Rice | Yield per Unit Area | 1000-Grain |
|---|---|---|---|
| | (mg/kg) | (kg/mu) | Weight (g) |
| Extra-Example 1 | 0.06 | 687 | 26.5 |
| Extra-Example 2 | 0.15 | 759 | 27.9 |
| Extra-Example 3 | 0.09 | 762 | 28.9 |
| Extra-Example 4 | 0.12 | 742 | 28.2 |
| Extra-Example 5 | 0.14 | 733 | 27.3 |

It can be seen from Extra-Table 2 that Extra-Example 3, with a Mg/Al mass ratio of 3:1 and appropriate amounts of trace elements, performed the best in cadmium pollution remediation and rice yield-rice cadmium content was 0.09 mg/kg, yield reached 762 kg/mu, and 1000-grain weight was 28.9 g. This is mainly attributed to the efficient immobilization of cadmium ions by the Mg—Al intercalated two-dimensional nano-functional structure formed by the hydrolysis of magnesium and aluminum. Simultaneously, calcium inhibits crop uptake of cadmium through ion competition; elements such as iron and manganese promote the conversion of cadmium into insoluble CdS/CdCO3 forms by participating in soil redox reactions, further improving the immobilization rate; silicon induces the formation of a silicon-cadmium co-precipitation layer and iron-manganese film on crop roots, blocking rice uptake of cadmium; zinc, copper, and molybdenum alleviate cadmium toxicity by activating the antioxidant enzyme system, while zinc and boron synergistically promote auxin synthesis, improving photosynthetic efficiency; lanthanum reduces cadmium transport by altering cell membrane permeability, while manganese and molybdenum jointly regulate nitrogen metabolism. Through the synergistic effect between the main components magnesium and aluminum and the trace elements, it ensures the immobilization of cadmium while achieving an increase in crop yield and quality. However, low contents of trace elements affected crop yield (Extra-Example 1), high contents of trace elements affected the immobilization of cadmium (Extra-Example 2), and the Mg/Al ratios affected the cadmium immobilization rate. Therefore, the best composition of the composite material was made at the Mg/Al ratios of 1:1-6:1 and the trace element contents of calcium 0.5%-1.5%, iron 0%-1.0%, copper 0.05%-0.5%, zinc 0%-1.0%, boron 0.05%-0.4%, lanthanum 0.05%-0.5%, molybdenum 0.05%-0.1%, manganese 0%-1.0%, and silicon 0.1%-1.0%.

### Extra-Example 6

### Verification of Ultra-Stable Mineralization Performance of Mg—Al Alloy Material for Heavy Metals.

Magnesium ingot and aluminum ingot with a mass ratio of 3:1 were selected as the main components, supplemented with 1.5% calcium, 1.0% iron, 0.5% copper, 0.5% zinc, 0.1% boron, 0.4% lanthanum, 0.1% molybdenum, and 1.0% silicon. Prepared by the melt atomization method: high-purity magnesium ingot, aluminum ingot, and trace components were mixed in proportion, added to a vacuum induction melting furnace under argon protection, heated to 800° C. at a rate of 5° C. per minute, melted for 60 minutes, cooled to 750° C. at a rate of 3° C. per minute, and then held at the 750° C. temperature, during which stirring was applied with an alternating magnetic field with a frequency of 50 Hz and an intensity of 0.1 T for 10 minutes; an atomization device with an atomization disc diameter of 200 mm and a rotation speed of 1600 r/min was used to perform atomization under argon atmosphere protection, controlling the particle size distribution by adjusting the atomization pressure and gas flow rate, the atomization tank of the atomization device was controlled below 30° C. by an ammonia refrigeration system, to obtain spherical magnesium-aluminum alloy composite particles with a particle size of 0.01-2 mm; the obtained granular material was treated in microwave plasma for 10 minutes for surface activation, obtaining regular spherical alloy with a smooth surface and a material particle size of 0.01-2 mm.

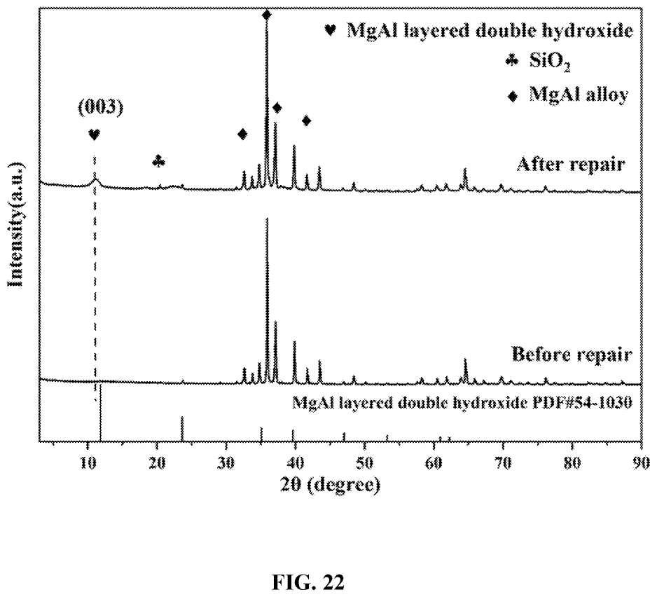

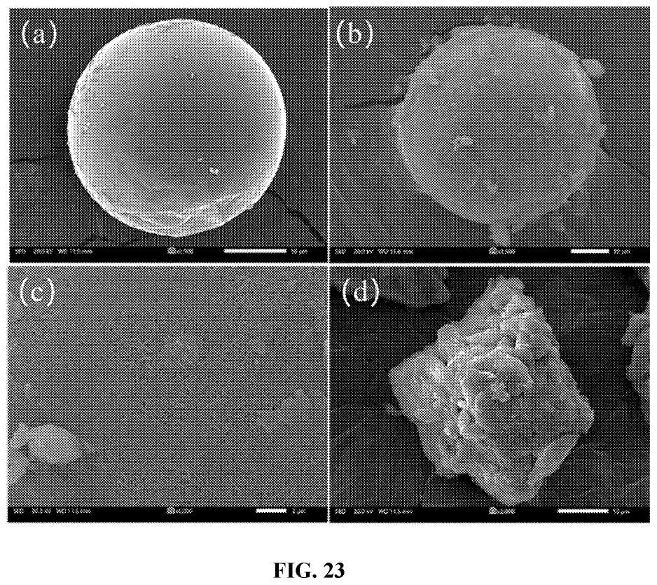

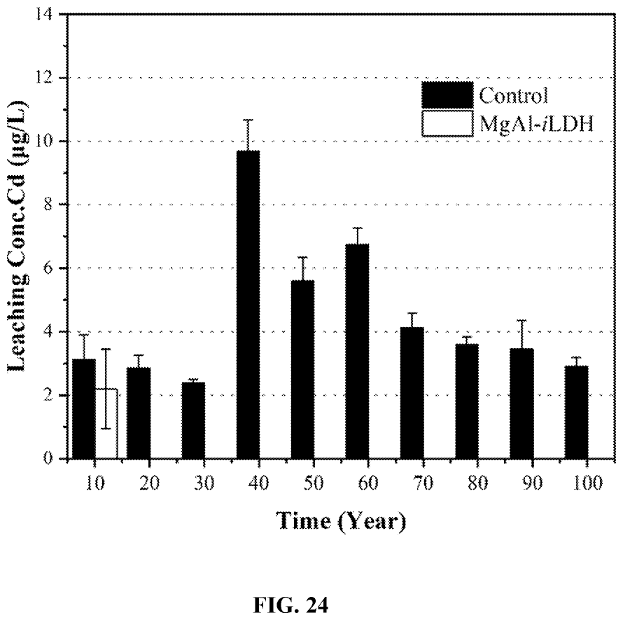

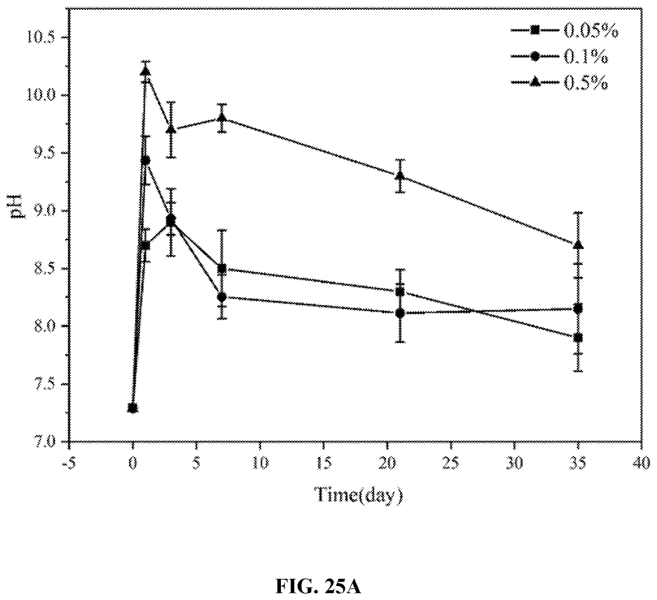

This material was added to soil contaminated with 25 mg/kg cadmium at mass ratios of 0.1%, 0.5%, and 1.0%, mixed, and incubated with moisture for 130 days. Soil available cadmium was extracted with a diethylenetriaminepentaacetic acid (DTPA) extraction solution at a solid-to-liquid ratio of 1:2 and pH 7.3, and its content was determined by inductively coupled plasma mass spectrometry (ICP-MS). The results showed that the available cadmium concentration decreased from 14.52 mg/kg in the original soil to 2.39, 1.44, and 0.88 mg/kg, respectively, with immobilization rates reaching 83.5%, 90.1%, and 93.9%. Characterization of the soil after composite material remediation by X-ray diffraction (XRD), scanning electron microscopy (SEM), and X-ray photoelectron spectroscopy (XPS) revealed that a layered Mg—Al intercalated two-dimensional nanofunctional material was formed in-situ on the material surface. XRD showed a typical Mg—Al intercalated two-dimensional nanofunctional material characteristic peak at 20=11.14°, and SEM observed a flaky crystal structure of 50-100 nm, see FIGS. 22-23. Further simulated acid rain leaching experiments, at pH 5.6, after 100 cycles, the cadmium leaching concentration was 0, verifying the ultra-stable mineralization and long-term stability of the material for heavy metals, see FIG. 24.

### Extra-Example 7

### Verification of the Regulation Effect on Soil Physicochemical Properties and Redox Potential

Using magnesium powder and aluminum powder in a mass ratio of 2:1 as the main components, supplemented with 0.5% calcium, 0.5% copper, 0.5% zinc, 0.2% boron, 0.3% lanthanum, 0.1% molybdenum, 0.5% manganese, and 1.0% silicon powder. Prepared by the mechanical ball milling method: magnesium, aluminum, and trace components were mixed in proportion and loaded into a vacuum ball milling jar. A mixed grinding medium of 10 mm zirconia ceramic balls and 15 mm cemented carbide beads was used in a mass ratio of 1:1, with a ball-to-material ratio of 8:1. Inert gas was introduced for protection, and 0.5-1 wt % stearic acid was added as a process control agent. A two-stage ball milling process was adopted: the first stage at 400 r/min for 2 hours for coarse crushing, the second stage at 200 r/min for 4 hours for fine alloying, finally obtaining composite particles with a particle size of 0.05-2 mm.

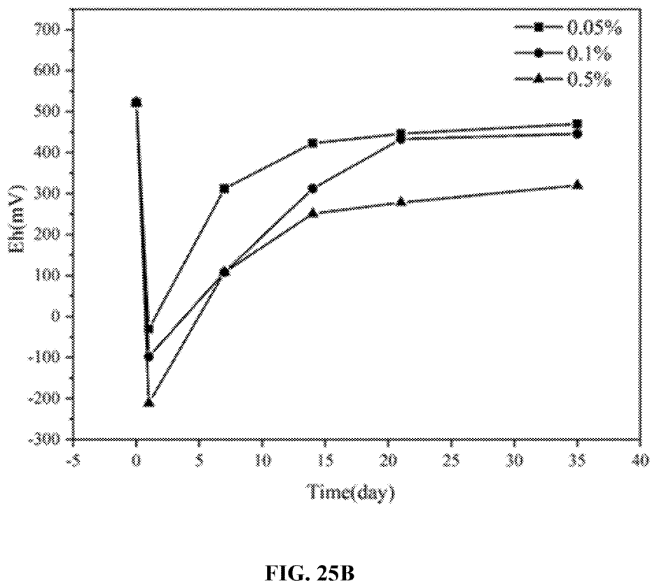

The material was applied at a rate of 200 kg/mu to soil with a pH of 7.29 and a cadmium content of 25 mg/kg. After rotary tillage to a depth of 20 cm, samples were taken periodically. Soil pH was measured using a pH meter, and the redox potential (Eh) meter was inserted into the soil layer 2-3 cm deep and left to stand for 30 minutes before reading. The available content of magnesium, molybdenum, nickel, and manganese was determined by DTPA extraction combined with inductively coupled plasma optical emission spectrometry. Experiments showed that soil pH increased from 7.29 to 9.44, Eh decreased from 522 mV to a minimum of −98 mV, and then slowly increased. After 35 days, Eh was still lower than the initial state. The available content of magnesium, molybdenum, nickel, and manganese first increased and then decreased, with maximum increases of 1.4 times, 3.9 times, 1.9 times, and 3.9 times, respectively, see FIGS. 25A-25B and Extra-Table 3.

EXTRA-TABLE 3
Available Concentrations of Mg, Mo, Ni and Mn in Soil with Time
After Adding Remediation Material

| | Mg (mg/kg) | Mo (ug/kg) | Ni (ug/kg) | Mn (mg/kg) |
|---|---|---|---|---|
| Day 1 | 130.8 | 7.5 | 90.5 | 5.4 |
| Day 3 | 182.3 | 24.4 | 148.1 | 16.5 |
| Day 7 | 189.6 | 29.1 | 126.7 | 12.5 |
| Day 21 | 159.1 | 22.4 | 43.2 | 3.5 |
| Day 35 | 151.8 | 13.2 | 53.1 | 3.1 |

### Extra-Example 8

### Verification of Microbial Community Optimization and Ecological Function Improvement

Using magnesium ingot and aluminum ingot in a mass ratio of 1:1 as the main components, adding 0.5% calcium, 0.1% iron, 0.5% copper, 1.0% zinc, 0.1% boron, 0.2% lanthanum, 0.05% molybdenum, 1.0% manganese, and 1.0% silicon, a composite material with a particle size of 0.01-2 mm was prepared by the melt atomization method. The material was applied to soil with a pH of 6.52 and a cadmium content of 33.8 mg/kg. Samples were taken for analysis after 35 days of incubation, and a control group (soil without adding the composite material) was carried out.

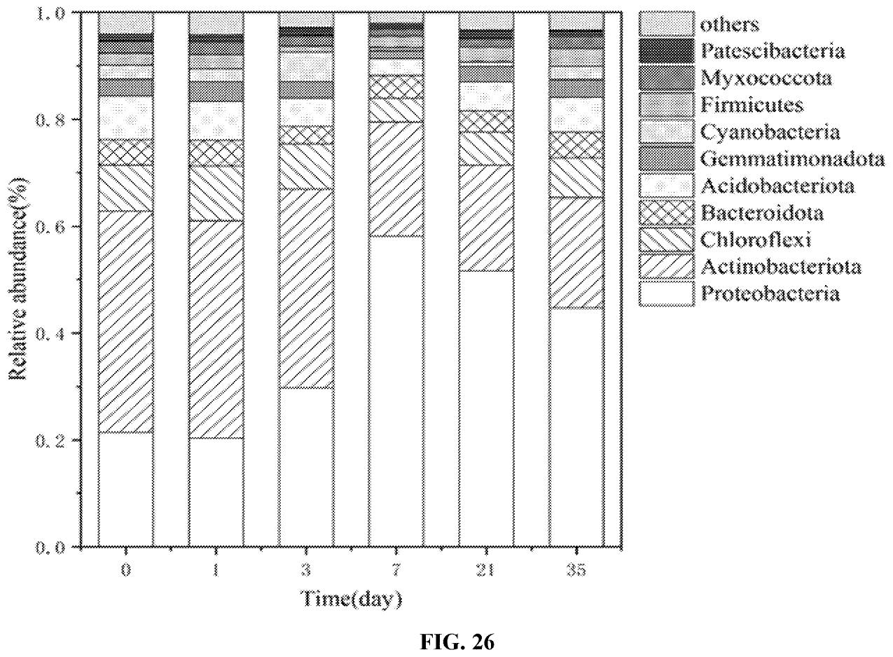

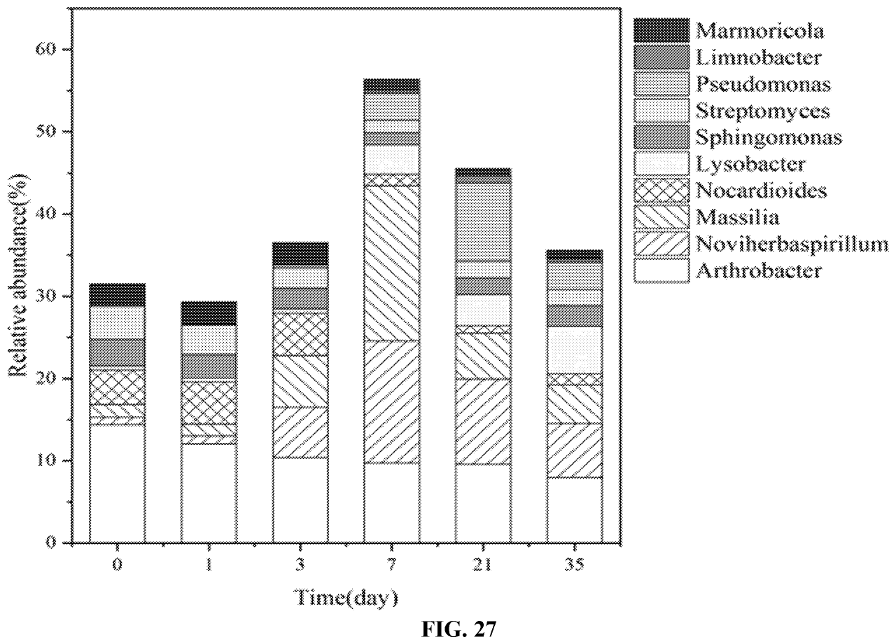

Total microbial DNA was extracted from the soil. Primers 338F/806R were used for PCR amplification targeting the V3-V4 region of the 16S rRNA gene. High-throughput sequencing was performed on the Illumina Nextseq 2000 platform, and community diversity and structure were analyzed using the Majorbio Cloud Platform. The results showed that microbial α-diversity increased after adding the remediation material, see Extra-Table 4. The abundance of Proteobacteria increased from 20% to 65%. The dominant bacterial genus shifted from Arthrobacter to Noviherbaspirillum (abundance 14.9%) and Massilia (abundance 18.8%), see FIGS. 26-27. Further screening by linear discriminant analysis and size effect revealed that the material-treated group was enriched with bacterial groups associated with heavy metal tolerance, and the expression level of cadmium tolerance genes in the soil increased by 2.1 times, confirming the enhanced cadmium immobilization capacity of the microbial community.

EXTRA-TABLE 4
Microbial Diversity Index Changes with Time After Adding
Remediation Material

| | Ace | Chao | Shannon | Simpson |
|---|---|---|---|---|
| Day 1 | 3781.8 | 3703.5 | 5.95 | 0.014 |
| Day 3 | 3990.5 | 3790.3 | 5.53 | 0.026 |
| Day 7 | 3463.3 | 3301.4 | 5.03 | 0.038 |
| Day 21 | 4117.8 | 3999.4 | 6.03 | 0.017 |
| Day 35 | 4628.6 | 4472.0 | 6.30 | 0.018 |

### Extra-Example 9

Preparation of composite material by melt atomization followed by mechanical ball milling, specifically comprising the following steps:
(1) Mix magnesium ingot and aluminum ingot with purity ≥99.95% in a mass ratio of 3:1, place them into a vacuum induction melting furnace under argon protection, heat to 800° C. at a heating rate of 5° C./min, hold and melt for 60 minutes, then cool to 750° C. at 2° C./min and hold, during which apply stirring with a pulsed magnetic field with a frequency of 35 Hz and an intensity of 0.1 T;
(2) Use a double-layer atomization disc with an upper layer diameter of 160 mm and a lower layer diameter of 210 mm, perform atomization under a nitrogen-argon mixed atmosphere, control the upper layer rotation speed at 19000 r/min, the lower layer rotation speed at 13000 r/min, and the atomization pressure at 0.5 MPa, to obtain matrix particles with a particle size of 0.2-1.5 mm; the volume ratio of nitrogen to argon in the nitrogen-argon mixed atmosphere is 1:3;
(3) Mix the atomized particles with trace element powders (1.5% calcium, 1.0% iron, 0.3% copper, 0.5% zinc, 0.2% boron, 0.2% lanthanum, 0.1% molybdenum, 0.2% manganese, and 1.0% silicon) in proportion, and load them into a temperature-controlled ball milling jar;
(4) In the first stage, use 3 mm alumina ceramic beads and 6 mm tungsten carbide beads in a mass ratio of 2:1, with a ball-to-material ratio of 8:1, ball milling at a speed of 300 r/min for 45 minutes, with the temperature controlled at 20° C.;
(5) In the second stage, use 5 mm zirconia ceramic beads, with a ball-to-material ratio of 5:1, ball milling at a speed of 200 r/min for 2.5 hours, with the temperature controlled at 35° C.;
(6) After airflow classification and vibration screening, a composite material consists of 10% of 0.01-0.1 mm particle sizes, 70% of 0.1-1 mm and 20% of 1-2 mm.

### Extra-Example 10

Preparation of composite material by the melt atomization method, specifically comprising the following steps:
(1) Mix magnesium ingot, aluminum ingot (mass ratio 3:1) with purity ≥99.95% and trace element powders (1.5% calcium, 1.0% iron, 0.3% copper, 0.5% zinc, 0.2% boron, 0.2% lanthanum, 0.1% molybdenum, 0.2% manganese, and 1.0% silicon), place them into a vacuum induction melting furnace under argon protection, heat to 800° C. at 7° C./min, melt for 60 minutes, then cool to 750° C. at 3° C./min and hold, while simultaneously applying stirring with a cross magnetic field with a frequency of 50 Hz and an intensity of 0.2 T for 10 minutes;
(2) Use an atomization disc with a diameter of 195 mm and a rotation speed of 16000 r/min to perform atomization under argon atmosphere, controlling the atomization tank temperature ≤30° C., to obtain spherical composite particles with a particle size of 0.05-2 mm;
(3) Treat the particles in microwave plasma with Ar/H2 mixed gas at a power of 1 kW for 8 minutes for surface activation.

### Extra-Example 11

Preparation of composite material by the mechanical ball milling method, specifically comprising the following steps:
(1) Mix magnesium powder, aluminum powder (mass ratio 3:1) with purity ≥99.95% and trace element powders (1.5% calcium, 1.0% iron, 0.3% copper, 0.5% zinc, 0.2% boron, 0.2% lanthanum, 0.1% molybdenum, 0.2% manganese, and 1.0% silicon), load them into a vacuum ball milling jar;
(2) Use 10 mm zirconia ceramic beads and 15 mm cemented carbide beads in a mass ratio of 1:1, with a ball-to-material ratio of 8:1, introduce argon for protection and add 0.8 wt % stearic acid;
(3) The first stage at 400 r/min for 2 hours for coarse crushing;
(4) The second stage at 200 r/min for 4 hours for fine alloying;
(5) Obtain a composite material with a particle size of 0.05-2 mm after vibration screening.

The materials prepared in Extra-Examples 9-11 were respectively added at a mass ratio of 0.5% to soil with a pH of 7.29, a total cadmium concentration of 25 mg/kg, and an available cadmium concentration of 14.52 mg/kg. After incubation with moisture for 35 days, the effects on soil cadmium immobilization performance and soil physicochemical properties are shown in Extra-Table 5.

EXTRA-TABLE 5
Effects of Remediation Materials on Cadmium Immobilization
Performance and Physicochemical Properties

| | Available Cd | Immobilization | |
|---|---|---|---|
| Treatment | Content (mg/kg) | Rate % | pH |
| Extra-Example 9 | 1.38 | 90.5% | 9.12 |
| Extra-Example 10 | 4.32 | 70.2% | 8.35 |
| Extra-Example 11 | 2.27 | 84.4% | 8.92 |

### Extra-Example 12

The composite material prepared in Extra-Example 9 was applied to soil contaminated with 5.23 mg/kg cadmium and rice pot experiments were carried out. The water level was maintained at 1-2 cm of flooding but a drought treatment was applied by maintaining approximate 40% of soil water content during the grouting period.

### Extra-Example 13

Magnesium ingot and aluminum ingot with purity ≥99.95% in a mass ratio of 3:1 were mixed with trace element powders (1.5% calcium, 1.0% iron, 0.5% copper, 0.5% zinc, 0.2% boron, 0.2% lanthanum, 0.1% molybdenum, 0.5% manganese, and 1.0% silicon) and loaded into a vacuum induction melting furnace. Under argon protection, they were heated to 800° C. at a heating rate of 8° C./min, melted for 60 minutes, cooled to 750° C. at a cooling rate of 3° C./min and held at the temperature. Simultaneously, stirring with an alternating magnetic field with a frequency of 50 Hz and an intensity of 0.2 T was applied for 10 minutes to fully homogenize the alloy melt. Atomization was performed using an atomization disc with a diameter of 195 mm under argon atmosphere protection, controlling the rotation speed at 16500 r/min. By adjusting the atomization pressure and gas flow rate, and using an ammonia refrigeration system to maintain the atomization tank temperature at 25-28° C., spherical composite particles with a particle size of 0.01-2 mm were obtained. The obtained granular material was treated in microwave plasma for 5 minutes for surface activation to prepare the target material. The material was applied at a rate of 150 kg/mu to soil contaminated with 5.23 mg/kg cadmium, with a rotary tillage depth of 20 cm, and a upland rice of Hanxiang 1 was planted.

### Extra-Example 14

Magnesium ingot and aluminum ingot with purity ≥99.95% in a mass ratio of 3:1 were mixed with 1.5% calcium, 1.0% iron, 0.3% copper, 0.5% zinc, 0.2% boron, 0.2% lanthanum, 0.1% molybdenum, 0.2% manganese, and 1.0% silicon powder. The composite material was prepared by the method of melt atomization followed by mechanical ball milling. The composite material was applied in combination with lime nitrogen. A ditch 30 cm deep was dug at a distance of 30 cm from the planted crop. The composite material was applied, covered with soil for 10 cm, and then a certain amount of lime nitrogen was applied. The application rates of the composite material and lime nitrogen were 20 kg/mu in total. Through the synergistic effect of the slow release of magnesium and aluminum elements from the composite material and lime nitrogen, the pH increased from 4.58 to 6.5-7.5, and the immobilization efficiency for cadmium was increased by 8.71-11.7% compared to applying the composite material alone or lime nitrogen alone.

### Extra-Example 15

Magnesium powder and aluminum powder in a mass ratio of 1:1 were mixed with 1.5% calcium, 1.0% iron, 0.5% copper, 0.1% zinc, 0.4% boron, 0.2% lanthanum, 0.1% molybdenum, 0.2% manganese, and 1.0% silicon powder. The composite material was prepared by the mechanical ball milling method. The composite material was applied in combination with potassium humate. A ditch 20 cm deep was dug at a distance of 25 cm from the planted crop. The composite material was applied, covered with soil for 5 cm, and then a certain amount of potassium humate was applied. The application rates of the composite material and potassium humate were 20 kg/mu in total. Through the synergistic enhancement of the ion exchange effect of the Mg—Al intercalated two-dimensional nanofunctional material of the composite material and the chelation effect of carboxyl/phenolic hydroxyl functional groups in the humus, the immobilization efficiency for cadmium was increased by 8.77%-19.1%, and the crop yield increased by 10.2%-22.9%.

### Extra-Example 16

Magnesium ingot and aluminum ingot with purity ≥99.95% in a mass ratio of 6:1 were mixed with 1.0% calcium, 1.0% iron, 0.1% copper, 0.5% zinc, 0.1% boron, 0.5% lanthanum, 0.1% molybdenum, 0.2% manganese, and 1.0% silicon powder. The composite material was prepared by the melt atomization method. The composite material was applied in combination with Bacillus subtilis. The composite material was applied by rotary tillage in a depth of 20 cm and at a rate of 50 kg/mu. Bacillus subtilis was applied by irrigation at an inoculation amount of 2×10⁸ CFU/g. The slow release of trace amounts of H₂ and nutrients from the composite material promoted bacterial colonization. Utilizing the biological nitrogen-fixing/phosphate-solubilizing characteristics of the functional bacterial agent formed a micro-ecological regulation system, increasing the populations of beneficial microorganisms in the soil by 3-5 times, while improving the crop's absorption and utilization efficiency of nitrogen, phosphorus, and potassium elements by 15-30%.

### Comparative Example Extra-1

Compared with Extra-Example 8, the soil was sterilized by exposure to steam at 80-100° C. for 30-60 minutes before adding the remediation material.

Extra-Example 8 and Comparative Example Extra-1 were compared to analyze the effect of the remediation material on the available cadmium content in soil under conditions with and without indigenous microorganisms. The results are shown in Extra-Table 6.

EXTRA-TABLE 6
Effect of Remediation Material on Soil Available Cadmium under
Different Microbial Conditions

| | Available Cd | Immobilization |
|---|---|---|
| Treatment | Content (mg/kg) | Rate % |
| Control | 18.7 | / |
| Extra-Example 8 | 3.22 | 82.8% |
| Comparative Example Extra-1 | 8.78 | 53.0% |

As can be seen from Extra-Table 6, in natural soil containing indigenous microorganisms, the immobilization rate of cadmium after adding the remediation material reached 82.8%; while after sterilization treatment, the immobilization rate of cadmium by the remediation material decreased to 53.0%, indicating that indigenous microorganisms played an important role in the cadmium immobilization process, contributing 29.8%. The composite material of Extra-Example 8 can improve the soil microbial flora to achieve a better cadmium immobilization effect.

### Comparative Example Extra-2

Compared with Extra-Example 9, the melting temperature was 900° C.

### Comparative Example Extra-3

Compared with Extra-Example 9, a single-layer atomization disc was used, with an atomization disc diameter of 200 mm and a rotation speed of 15000 r/min.

### Comparative Example Extra-4

Compared with Extra-Example 9, a single-stage ball milling process was used, ball milling at 300 r/min for 3 hours.

### Comparative Example Extra-5

Compared with Extra-Example 10, the melting temperature was 900° C.

### Comparative Example Extra-6

Compared with Extra-Example 10, no surface activation treatment was performed.

### Comparative Example Extra-7

Compared with Extra-Example 11, a single-stage ball milling process was used, at 400 r/min for 4 hours.

Comparative Extra-Examples 2-7 used different preparation methods and parameters to prepare composite materials with different particle sizes. They were respectively added at a mass ratio of 0.5% to soil with a pH of 7.29, a total cadmium concentration of 25 mg/kg, and an available cadmium concentration of 14.52 mg/kg. After incubation with moisture for 35 days, the effects on soil cadmium immobilization performance and soil physicochemical properties are shown in Extra-Table 7.

EXTRA-TABLE 7
Effects of Remediation Materials on Cadmium Immobilization
Performance and Physicochemical Properties

| | Available | | | |
|---|---|---|---|---|
| | Cd Content | Immobilization | | Eh |
| Treatment | (mg/kg) | Rate % | pH | (mV) |
| Comparative Example Extra-2 | 4.89 | 66.3% | 8.12 | 322 |
| Comparative Example Extra-3 | 3.22 | 77.8% | 8.23 | 317 |
| Comparative Example Extra-4 | 4.29 | 70.5% | 8.19 | 308 |
| Comparative Example Extra-5 | 6.82 | 53.0% | 7.91 | 354 |
| Comparative Example Extra-6 | 8.97 | 38.2% | 7.58 | 423 |
| Comparative Example Extra-7 | 3.99 | 72.5% | 8.80 | 298 |

The preparation method and key parameters significantly affect the performance of the composite material in remediating soil cadmium pollution. Referring to Extra-Table 5 and Extra-Table 7, it can be seen that compared with Comparative Examples Extra-2 to Extra-4, Extra-Example 9, using a melting temperature of 800° C., avoided uneven composition caused by element volatilization at the high temperature of 900° C., obtained more uniform matrix particles through the double-layer atomization disc, and achieved particle refinement and thorough mixing of trace elements through the two-stage ball milling process. The final material had a cadmium immobilization rate of 90.5%, significantly higher than the 66.3% immobilization rate of Comparative Example Extra-2, the 77.8% immobilization rate of Comparative Example Extra-3, and the 70.5% immobilization rate of Comparative Example Extra-4. It also more effectively raised soil pH and lowered Eh, optimizing the immobilization environment. Compared with Comparative Examples Extra-5 to Extra-6, Extra-Example 10, with a melting temperature of 800° C. superior to 900° C. for reducing element loss, and with microwave plasma surface activation treatment significantly enhancing particle reactivity, had an immobilization rate of 70.2%, much higher than the 53.0% of Comparative Example Extra-5 and the 38.2% of Comparative Example Extra-6, and also had better regulating effects on soil pH and Eh. Compared with Comparative Example Extra-7, Extra-Example 11, using the two-stage ball milling process, ensured better particle refinement and composition uniformity than single-stage ball milling, with an immobilization rate of 84.4% higher than the 72.5% of Comparative Example Extra-7, and its regulation of soil physicochemical properties was more conducive to the stable immobilization of cadmium.

### Comparative Example Extra-8

Compared with Extra-Example 12, no remediation material was added to the soil as a control treatment.

### Comparative Example Extra-9

Compared with Extra-Example 12, after applying the composite material to the soil, 1-2 cm of flooding was maintained throughout the entire rice growth period.

### Comparative Example Extra-10

Compared with Comparative Example Extra-8, 1-2 cm of flooding was maintained throughout the entire rice growth period.

### Comparative Example Extra-11

Compared with Comparative Example Extra-8, a commercially available biochar passivation material was added to the soil.

### Comparative Example Extra-12

Compared with Comparative Extra-Example 8, a commercially available foliar barrier agent was sprayed during the rice grouting period.

Comparing Example Extra-12 and Comparative Examples Extra-10 to Extra-12, the cadmium content in rice grains grown in soil with different water management and different remediation materials is shown in Extra-Table 8.

EXTRA-TABLE 8
Cadmium Content in Rice Grains

| Group | Cd Concentration (mg/kg) |
|---|---|
| Example Extra-12 | 0.08 |
| Comparative Example Extra-8 | 0.86 |
| Comparative Example Extra-9 | 0.05 |
| Comparative Example Extra-10 | 0.34 |
| Comparative Example Extra-11 | 0.42 |
| Comparative Example Extra-12 | 0.56 |

The experimental results show that the magnesium-aluminum alloy composite material prepared in Extra-Example 12 presents a significantly high remediation efficiency for soil contaminated with 5.23 mg/kg cadmium. Without applying the composite material, the cadmium content in the rice grains was 0.86 mg/kg (Comparative Example Extra-8) while it was reduced to 0.08 mg/kg by applying the composite material in Extra-Example 12, which even involved drought treatment during the rice grain grouting period. No significant differences in rice cadmium content were observed as compared with Comparative Example Extra-9 in which water flooding was maintained throughout the entire rice growth period, indicating that the composite material maintains a good remediation effect under both drought and flooding conditions. Comparative Example Extra-10, without applying the composite material but flooded throughout, demonstrated a certain degree of Cd immobilization, indicating that water management conditions can promote the soil self-remediation process. Furthermore, the remediation effect of this composite material was significantly better than that of commercially available biochar (Comparative Example Extra-11) and spraying commercially available foliar barrier agent (Comparative Example Extra-12). The superior performance of the invented composite materials is attributed to the synergistic effect of chemical and microbial immobilization. Specifically: (1) In-situ formation of Mg—Al intercalated two-dimensional nano-functional material achieves ultra-stable mineralization of cadmium; (2) the composite material maintains a low Eh environment in the soil, thus promoting Fe—Mn—S redox cycling, accelerating soil self-remediation, and forming an iron film in the rhizosphere, and inhibiting rice uptake of cadmium. (3) It improves the soil microbial community structure and promotes the growth of cadmium-immobilizing microorganisms.

### Comparative Example Extra-13

Compared with Extra-Example 13, no material was added to the soil as a control treatment.

### Comparative Example Extra-14

Compared with Extra-Example 13, no trace elements were added during the material preparation process.

### Comparative Example Extra-15

Compared with Comparative Example Extra-13, a commercially available soil conditioner was added to the soil. This soil conditioner contains calcium and magnesium ≥10%, zinc ≥0.2%, iron ≥0.1%, copper ≥0.05%, sulfur ≥10%, boron ≥0.2%, manganese ≥0.05%, and molybdenum ≥0.001%.

Extra-Example 13 and Comparative Examples Extra-13 to Extra-15 demonstrate the effects of the trace elements and the performance of a commercially available soil conditioner on the yield and quality of upland rice. The results are shown in Extra-Table 9.

EXTRA-TABLE 9
Yield and Quality of Upland Rice Grains

| | Cd | | 1000- | | Folic |
|---|---|---|---|---|---|
| | Content | Yield per | Grain | Protein | Acid |
| | in Grains | Unit Area | Weight | Content | Content |
| Group | (mg/kg) | (kg/mu) | (g) | (%) | (μg/100 g) |
| Extra-Example 13 | 0.08 | 750 | 28.5 | 20.1% | 10.12 |
| Comparative | 0.78 | 622 | 24.8 | 18.6% | 9.07 |
| Example Extra-13 | | | | | |
| Comparative | 0.12 | 655 | 25.1 | 18.9% | 9.13 |
| Example Extra-14 | | | | | |
| Comparative | 0.89 | 735 | 27.7 | 19.4% | 9.52 |
| Example Extra-15 | | | | | |

As can be seen from Extra-Table 9, the Mg—Al based composite material of the present invention exhibits significant technical advantages in remediating heavy metal-contaminated soil and improving crop quality and yield. As shown in Extra-Example 13, which uses the magnesium-aluminum alloy material containing a specific combination of trace elements, the cadmium content in upland rice grains was 0.08 mg/kg, a reduction of 89.7% compared to Comparative Example Extra-13 (no material added to the soil), and was significantly better than the 0.89 mg/kg of Comparative Example Extra-15 (a commercially available conditioner). It is noted that the application of magnesium-aluminum alloy material without doping trace elements in Comparative Example Extra-14 presents a relatively low rice cadmium concentration of 0.12 mg/kg, but its effect on improving the rice yield and quality is limited. The rice grain yield per unit area (655 kg/mu) and protein content (18.9%) were only 5.3% and 1.6% higher than those of Comparative Example Extra-13 (no material added), respectively, far lower than the 20.6% increase in yield per unit area and 8.1% increase in protein content observed in Extra-Example 13 compared to Comparative Example Extra-13. Although satisfactory yield and quality of rice were obtained by the commercially available conditioner in Comparative Example Extra-15, rice cadmium concentration was even higher than that in Comparative Example Extra-13 (no material applied). This phenomenon reveals the technical contradiction between “yield” and “quality (cadmium content)” in soil remediation. In contrast, the present invention achieves a dual breakthrough in rice yield and quality through the synergistic effect of the situ Mg—Al intercalated two-dimensional nanomaterials and the specific trace elements. The technical effect of the present invention exceeds the reasonable expectations of those skilled in the art.

Therefore, the present invention adopts the above-mentioned composite material for remediating heavy metal-contaminated soil, its preparation method and use. After the composite material is applied to the soil, the magnesium-aluminum alloy hydrolyzes to generate in-situ Mg—Al intercalated two-dimensional nanomaterials. Soil aggregates can also serve as heterogeneous carriers for the nucleation and growth of the Mg—Al intercalated two-dimensional nanomaterials, achieving ultra-stable mineralization of heavy metals such as cadmium and lead. The soil after applying the composite material has long-term stability performance. Simulating the soil aging process over 100 years, cadmium still exists in a stable form, with no leaching and free of secondary pollution. It exhibits significant cadmium immobilization effect in soils with a wide pH range, breaking through the bottleneck of traditional remediation materials being limited by soil pH. Even under extreme drought climate conditions, it can maintain a low redox potential for a long time, increasing the concentration of Fe2+ and Mn2+ in the root system and inducing the formation of a dense iron film, inhibiting the crop root's absorption of cadmium, significantly reducing the cadmium content in rice.

The invented composite materials can regulate soil physicochemical properties and redox potential, release magnesium, silicon, and trace elements, enhance crop photosynthesis, slowly generate trace amounts of hydrogen, improve soil structure, air permeability, water retention and looseness, inhibit soil acidification, improve plant stress resistance, regulate plant growth and development, and enhance drought resistance and pest and disease resistance. It can achieve long-term reduction of soil redox potential, reduce soil redox potential from 522 mV to −98 mV, promote soil Fe—Mn—S redox cycles, and accelerate the soil self-remediation process.

The composite material can achieve microbial community optimization and ecological function improvement: enhancing microbial a diversity, optimizing soil ecological functions. Promoting the abundance of Proteobacteria from 20% to 55%-65%, transforming the dominant bacterial genus from Arthrobacter to cadmium-tolerant Noviherbaspirillum and Massilia, enhancing heavy metal immobilization capacity.

The composite material is prepared by melt atomization, mechanical ball milling, or melt atomization followed by mechanical ball milling, with controllable particle size, high sphericity, uniform composition, suitable for large-scale production; during application, the composite material is applied along with rotary tillage of the land, and crops can be planted immediately. The remediation method is simple, with high remediation efficiency and no need for additional equipment.

The composite material significantly improves crop yield and quality. By releasing magnesium, silicon and trace elements, it provides sufficient nutrients for crop growth, promotes root development and leaf photosynthesis in crops like rice, regulates soil redox potential, effectively blocks heavy metal absorption, ensures healthy crop growth, and significantly enhances the safety and quality of agricultural products. It increases rice yield by 20.6%, thousand-grain weight by 14.9%, protein content by 8.1%, and folic acid content by 11.6%, demonstrating that the composite material can meet the multiple needs of soil remediation, crop quality and yield improvement for agricultural production.

What is claimed is:

1. A composite material which is used for soil remediation, and is suitable for chemical removal and degradation of complex contaminants from an acidic to alkaline environment, wherein
the composite material consists of aluminum alloys with at least one of alkaline-earth metals and transition metals, which are used for removal of chemical pollutants by being dissolved to release divalent metal ions, trivalent aluminum ions and hydroxide ions, which contact with other divalent and trivalent metal cations and anions in the contaminated soil, so as to perform an in situ self-assemble of two-dimensional Layered Double Hydroxides (LDH) precipitates;
the composite material is with a core-shell structure of Alloy@LDH, and is composed of aluminum core metal, a second type of zerovalent metal, and an auxiliary agent; the auxiliary agent is selected from silicon, silicon dioxide or stearic acid; the aluminum metal comprises 18-70 weight % of the composite material, the second type of zerovalent metal comprises 30-80% weight of the composite material, and the auxiliary agent comprises 0-2 weight % of the composite material;
a source of the aluminum metal is metallic aluminum, aluminum calcium alloy, aluminum magnesium alloy, aluminum iron alloy, aluminum zinc alloy, aluminum nickel alloy, aluminum manganese alloy, or aluminum silicon alloy; and
a source of the second type of zerovalent metal is at least one of elemental calcium, elemental magnesium, elemental iron, elemental zinc, elemental nickel and elemental manganese, or an alloy composed of two or more elements of calcium, magnesium, iron, zinc, nickel, and manganese.

2. The composite material of claim 1, wherein the second type of zerovalent metal is selected from alkaline-earth metals and/or transition metals, the alkaline-earth metal is selected from one or two of calcium and magnesium, and the transition metal is selected from one or more of iron, nickel, manganese, zinc;
the composite material is with a particle size of 0.01-3 mm;
the magnesium content is not less than the aluminum content, and a mass ratio of magnesium to aluminum is 1:1-6:1;
the total content of magnesium and aluminum together is 93-99.2 wt %;
a portion of said trace components is selected from a group consisting of calcium, iron, copper, zinc, manganese, silicon, each with a content not exceeding 1.5 wt %; and/or
other said trace components are selected from a group consisting of boron, lanthanum, molybdenum, each with a content not exceeding 0.5 wt %; and/or
the composite material is prepared by placing the source of the aluminum metal, the source of the second type of zerovalent metal and the auxiliary agent in a ball milling tank; and making the tank rotated at 3000-5000 rpm for 30-120 min after being vacuumed and filled with argon or nitrogen.

3. The composite material of claim 1, wherein the composite material is prepared by
1) putting the source of the aluminum metal and the source of the second type of zerovalent metal into a sintering furnace, which is vacuumed and filled with argon or nitrogen for 2 to 4 times;
2) sintering a mixture of the source of the aluminum metal and the source of the second type of zerovalent metal at a rate of 70-100° C./h to a sintering temperature 700-1500° C. and keeping sintering for 0.5-3 h;
3) cooling the sintering furnace to 200-400° C.) at a rate of 100-140° C.)/h, and then cooling the sintering furnace naturally to a room temperature;
4) breaking the mixture sintered into powders with particle sizes of less than 3 mm; and
5) putting the powders and auxiliary agent into a ball milling tank, which is vacuumed and filled with argon or nitrogen; and ball milled for 5-30 mins, so as to obtain the composite material.

4. The composite material of claim 1, wherein the sewage soil purification is used to remove contaminants from the contaminated soil via a REDOX reaction between the contaminants and the composite material, in which metal components are dissolved to make divalent metal ions and trivalent aluminum ions released to be further in situ self-assembled, so as to form two-dimensional, layered hydroxides, which further remove contaminants that are difficult or not removable by the REDOX reaction and degraded products and byproducts of primary contaminants through adsorption, co-precipitation, surface complexation, isomorphic substitution, intercalation and chemical catalytic degradation.

5. The composite material of claim 1, wherein the contaminants include heavy metals, chlorinated organic solvents, organic dyes, pesticides, endocrine disruptors, pentavalent arsenic, and/or nitrate;
the contaminants include carbonate ions, bicarbonate ions, sulfate ions, or chloride ions; and/or
a molar ratio between divalent metal ions and trivalent metal ions is controlled at 1:1 to 1:4.

6. The composite material of claim 1, wherein the composite material is pretreated with dilute HCl, so as to form core-shell micro-nano structures by coating LDH nanofilm on a surface of alloy for achieving more efficient remediation of contaminated soil; and/or
the composite material is used for soil remediation, having benefits of
detoxifying heavy metals by immobilization,
degrading organic pollutants chemically,
improving soil pH buffer capacity,
regulating soil microbial community,
raising soil Mg and hydrogen fertility, soil porosity, air permeability and water retention, and
improving nitrogen fixation by converting nitrate into ammonium, which is readily adsorbed on a surface of soil colloids to enter a lattice of clay minerals, and transform into guano stones.

7. A composite material for remedying soil and improving crop quality and yield, wherein
the composite material contains magnesium, aluminum, and trace components; the total content of all trace components is 0.8-7%;
the magnesium content is not less than the aluminum content, and a mass ratio of magnesium to aluminum is 1:1-6:1;
the total content of magnesium and aluminum together is 93-99.2 wt %;
a portion of said trace components is selected from a group consisting of calcium, iron, copper, zinc, manganese, silicon, each with a content not exceeding 1.5 wt %; and
other said trace components are selected from a group consisting of boron, lanthanum, molybdenum, each with a content not exceeding 0.5 wt %.

8. The composite material according to claim 7, wherein
the composite material contains 46-85 wt % magnesium and/or 13-49.6 wt % aluminum.

9. The composite material according to claim 7, wherein
an alloy phase of magnesium and aluminum is β-Mg₁₇Al₁₂; and/or
the composite material forms in-situ two-dimensional nano magnesium-aluminum intercalation in soil, causing at least a portion of heavy metals to be anchored in a crystal lattice along with sustained release of β-Mg₁₇Al₁₂, thereby improving a soil microbial community structure, thus enhancing a quality and yield of cultivated crops.

10. The composite material according to claim 7, wherein contents of the trace components are as follows:
Boron 0.05-0.4 wt %, Lanthanum 0.05-0.5 wt %, and Molybdenum 0.05-0.1 wt %, respectively; and/or
Calcium 0.5-1.5 wt %, Iron 0-1.0 wt %, Copper 0.05-0.5 wt %, Zinc 0-1.0 wt %, Manganese 0-1.0 wt %, and Silicon 0.1-1.0 wt %, respectively.

11. The composite material according to claim 7, wherein
the magnesium is derived from magnesium ingots or powder with a purity not less than 99.95%;
the aluminum is derived from aluminum ingots or powder with a purity not less than 99.95%;
the magnesium and aluminum are derived from magnesium-aluminum alloy powders with a purity of not less than 99.95% and particle size of 0.05-2 mm diameters; and/or
the trace components are derived from powders of calcium, iron, copper, zinc, boron, lanthanum, molybdenum, manganese, and/or silicon with a purity not less than 99.9%.

12. A method for preparing a composite material for remedying soil and improving crop quality and yield, wherein
a mechanical ball milling method is used to obtain non-spherical composite material particles with a rough surface and a particle size of 0.05-2 mm; and/or
a melt atomization method is used to obtain spherical composite material particles with a smooth, dense surface and a particle size of 0.01-2 mm.

13. The method according to claim 12, comprising the following steps:
(1) mixing magnesium ingots and aluminum ingots according to their mass ratio, placing a first mixture thereof in a vacuum induction melting furnace under argon protection, heating gradually at a rate of 3-8° C. per minute to 780-820° C., melting for 40-90 minutes, then cooling at a rate of 1-3° C. per minute to 720-780° C., then maintaining at the temperature while applying a pulsed magnetic field stirring with a frequency of 30-40 Hz and an intensity of 0.05-0.2 T;
(2) using a double-layer atomization disc with an upper layer diameter of 150-180 mm and a lower layer diameter of 200-220 mm for making atomization under a nitrogen-argon mixed atmosphere protection, controlling an upper layer rotation speed at 18000-20000 r/min, a lower layer rotation speed at 12000-15000 r/min, and an atomization pressure at 0.4-0.6 MPa, to obtain base particles with a particle size of 0.2-1.5 mm, in which a volume ratio of nitrogen to argon in the nitrogen-argon mixed atmosphere is 1:3;
(3) further mixing the atomized particles with a trace component powder according to their mass ratio, and placing a second mixture thereof into a ball milling jar with a temperature controlling function;
(4) adopting a two-stage ball milling process: a first stage which uses 3 mm alumina ceramic beads and 6 mm tungsten carbide beads in a mass ratio of 2:1, with a ball-to-material ratio of 8:1, milling at 280-320 r/min for 0.5-1 hour, with temperature controlled at 15-25° C.; and a second stage which uses 5 mm zirconia ceramic beads, with a ball-to-material ratio of 5:1, milling at 180-220 r/min for 2-3 hours, with temperature controlled at 30-40° C.; and
(5) after above ball milling, performing air classifying and vibration sieving to precisely control a final product particle size distribution within a range of 0.01-2 mm, in which particles sized 0.01-0.1 mm account for 8-12%; particles sized 0.1-1 mm account for 65-75%; and particles sized 1-2 mm account for 15-25%.

14. The method according to claim 12, wherein the melt atomization method comprises the following steps:
(1) mixing magnesium ingots, aluminum ingots, and trace component powder according to their mass ratio, placing their mixture in a vacuum induction melting furnace under argon protection, heating at a rate of 5-10° C. per minute to 800° C., melting for 25-110 minutes, then cooling at a rate of 2-5° C. per minute to 750° C. for holding, while applying an alternating magnetic field stirring with a frequency of 50 Hz and an intensity of 0.1-0.3 T for 10 minutes;
(2) using an atomization disc with a diameter of 190-200 mm and a rotating speed of 15000-18000 r/min for making atomization under an argon atmosphere protection, controlling a particle size distribution by adjusting an atomization pressure and a gas flow rate; an atomizing tank of an atomization equipment needs to be cooled by an ammonia refrigeration system to keep a temperature below 30° C., obtaining spherical magnesium-aluminum alloy composite particles with a particle size of 0.01-2 mm; and
(3) treating a particulate material obtained as above in a microwave plasma for 5-10 minutes for a surface activation.

15. The method according to claim 12, wherein the mechanical ball milling method comprises the following steps:
(1) mixing a magnesium powder, and aluminum powder, or mixing a magnesium-aluminum alloy powder, with a trace component powder according to their mass ratio, and putting their mixture into a vacuum ball milling jar;
(2) using a mixed grinding media of 10 mm zirconia ceramic beads and 15 mm cemented carbide beads in a mass ratio of 1:1, with a ball-to-material ratio of 8:1, introducing an inert gas protection, and adding 0.5-1 wt % stearic acid as a process control agent; and
(3) adopting a two-stage ball milling process: a first stage which mills at 400 r/min for 2 hours for coarse crushing, and a second stage which mills at 200 r/min for 4 hours for fine alloying, thus obtaining composite particles with a particle size of 0.05-2 mm.

16. The composite material according to claim 7, wherein
the composite material is applied to soil by a rotary tillage, with an application rate of 20-200 kg/mu (approx. 300-3000 kg/ha), and a rotary tillage depth of 10-30 cm;
after being applied to soil, the composite material forms in-situ magnesium-aluminum intercalated two-dimensional nano-functional materials, anchoring heavy metals in a crystal lattice, achieving an ultra-stable mineralization by immobilizing heavy metals to transform a dominant bacterial genus in the soil from Arthrobacter to heavy metal-tolerant growth-promoting genera Novosphingobium and Massilia, improving a soil microbial community structure, thereby enhancing a quality and yield of cultivated crops.

17. The composite material according to claim 16, wherein
the composite material is used in combination with an inorganic alkaline conditioner, and their mass ratio of composite material to inorganic alkaline conditioner is 1:0.5-1;
the composite material is used by digging a 20-30 cm deep trench 20-30 cm away from a crop, applying the composite material, covering with 5-10 cm of soil, and then applying the inorganic alkaline conditioner;
through a synergistic effect of a sustained release of magnesium and aluminum elements from the composite material and the inorganic alkaline conditioner, a soil pH is raised to a range of 6.5-7.5, inhibiting a soil acidification, and further improving an immobilization efficiency of cadmium.

18. The composite material according to claim 16, wherein
the composite material is used in combination with one or more of humic acid-based, amino acid-based, or lignin-based organic amendments; or
the composite material is used in combination with nitrogen-fixing/phosphate-solubilizing functional microbial agents.

19. The composite material according to claim 16, wherein
the composite material is used in combination with an organic amendment, their mass ratio of the composite material to the organic amendment is 1:0.3-1;
the composite material is used by digging a 20-30 cm deep trench 20-30 cm away from a crop, applying the composite material, covering with 5-10 cm of soil, and then applying the organic amendment;
through a synergistic enhancement of an ion exchange effect of a magnesium-aluminum intercalated two-dimensional nano-functional material formed by the composite material and a chelation effect of carboxyl/phenolic hydroxyl functional groups in the organic amendment, an immobilization efficiency of cadmium is further improved, resulting in an increased crop yield.

20. The composite material according to claim 16, wherein
the composite material is used in combination with nitrogen-fixing/phosphate-solubilizing functional microbial agents,
the composite material is applied by a rotary tillage, with a rotary tillage depth of 10-30 cm, and an application rate of 20-200 kg/mu (approx. 300-3000 kg/ha);
the microbial agent is cultivated and then applied via irrigation, with an inoculation amount of 1-3×10⁸ CFU/g;
through a slow release of trace amounts of H₂ and nutrient elements from the composite material, a colonization of a microbial community is promoted, and biological nitrogen fixation/phosphate solubilization characteristics of a functional microbial agent are utilized to form a micro-ecological regulation system, promoting an increase in the number of beneficial microorganisms in the soil, further enhancing an absorption and utilization efficiency of nitrogen, phosphorus, and potassium elements by crops.
